(19) United States
(12) Patent Application Publication
(10) Pub. No.: US 2026/0086864 A1
(43) Pub. Date: Mar. 26, 2026

(54) EVALUATION METHOD AND EVALUATION APPARATUS

(71) Applicant: Fujitsu Limited, Kawasaki-shi,Kanagawa (JP)

(72) Inventors: Haruki YAMANASHI, Kawasaki (JP); Toru KITAYAMA, Kobe (JP); Daiki YOSHIKAWA, Handa (JP); TAKUMI SAKAI, Ota (JP)

(73) Assignee: Fujitsu Limited, Kawasaki-shi, Kanagawa (JP)

(21) Appl. No.: 19/290,908

(22) Filed: Aug. 5, 2025

(30) Foreign Application Priority Data
Aug. 7, 2024 (JP) 2024-130909

(51) Int. Cl. G06F 9/50

(52) U.S. Cl. CPC G06F 9/5027

(57) ABSTRACT

An evaluation apparatus receives an input of a quality requirement of control software that controls execution of a cloud service according to a user input. Next, the evaluation apparatus specifies control software whose usage record satisfies the quality requirement based on an execution log in which situations in which the control software was used are recorded. The evaluation apparatus then displays the specified control software.

### CROSS-REFERENCE TO RELATED APPLICATION

This application is based upon and claims the benefit of priority of the prior Japanese Patent Application No. 2024-130909, filed on Aug. 7, 2024, the entire contents of which are incorporated herein by reference.

### FIELD

The embodiments discussed herein relate to an evaluation method and an evaluation apparatus.

### BACKGROUND

In recent years, cloud services have been utilized in business systems such as personnel management, customer management, and purchase management. A workflow control service that controls the flow of a series of business processes controls cloud services of a plurality of business systems. The workflow control service may use a “connector”, which is software for controlling a cloud service to be operated. A user of the workflow control service is capable of controlling cloud services via the connector.

One example of a technology related to cloud services that has been proposed is a method of providing an environment for identifying and evaluating resources that are at least partially standardized and interoperable. Data integration systems have also been proposed that allow seamless transitions between the various phases of design and implementation of a data integration process. See, for example, the following literatures.
Japanese Laid-open Patent Publication No. 2023-109842
Japanese National Publication of International Patent Application No. 2008-511934

### SUMMARY

In one aspect, there is provided a non-transitory computer-readable storage medium storing a computer program that causes a computer to perform a process including: receiving an input of a quality requirement of control software that controls execution of a cloud service in keeping with a user input; specifying control software whose usage record satisfies the quality requirement based on an execution log in which situations in which the control software was used are recorded; and displaying the specified control software.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts one example of an evaluation method according to a first embodiment;

FIG. 2 depicts an example information processing system according to a second embodiment;

FIG. 3 depicts example hardware of a control server;

FIG. 4 depicts one example of a workflow control service;

FIG. 5 is a block diagram depicting a function where a control server presents connectors that satisfy quality requirements based on usage records;

FIG. 6 depicts one example of a correspondence table;

FIG. 7 depicts one example of a setting difficulty level evaluation table;

FIG. 8 depicts one example of an execution multiplicity evaluation table;

FIG. 9 depicts one example of a recovery processing table;

FIG. 10 depicts one example of an automatic recovery simplicity evaluation table;

FIG. 11 depicts one example of a problem investigation simplicity evaluation table;

FIG. 12 depicts one example of a re-execution time management table;

FIG. 13 depicts one example of a processing type list;

FIG. 14 depicts one example of an operation results table;

FIG. 15 depicts one example of an update tracking evaluation table;

FIG. 16 depicts one example of multiple execution;

FIG. 17 depicts one example of a connector type selection screen;

FIG. 18 depicts one example of a quality requirement selection screen;

FIG. 19 depicts one example of a result presentation screen;

FIG. 20 is a flowchart depicting an example procedure of a quality evaluation process;

FIG. 21 is a flowchart depicting an example procedure of a setting difficulty level evaluation process;

FIG. 22 is a flowchart depicting an example procedure of an execution multiplicity evaluation process;

FIG. 23 is a flowchart depicting an example procedure of an automatic recovery simplicity evaluation process;

FIG. 24 is a flowchart depicting an example procedure of a problem investigation simplicity evaluation process;

FIG. 25 is a flowchart depicting an example procedure of a process of evaluating flexibility of linked service control;

FIG. 26 is a flowchart depicting an example procedure of an evaluation process for tracking of controlled service updates; and

FIG. 27 is a flowchart depicting an example procedure of a connector presentation process.

### DESCRIPTION OF EMBODIMENTS

When there are a plurality of connectors corresponding to one cloud service, a user who controls the cloud service selects a connector to be used. However, in cases where the user does not know which connector has a desired function when controlling the cloud service, the user will not be able to select an appropriate connector.

Hereinafter, embodiments will be described with reference to the accompanying drawings. Note that the respective embodiments may be implemented in combination with a plurality of embodiments within a range that remains technically consistent.

### First Embodiment

The first embodiment is an evaluation method that enables a user to appropriately select software for controlling a cloud service.

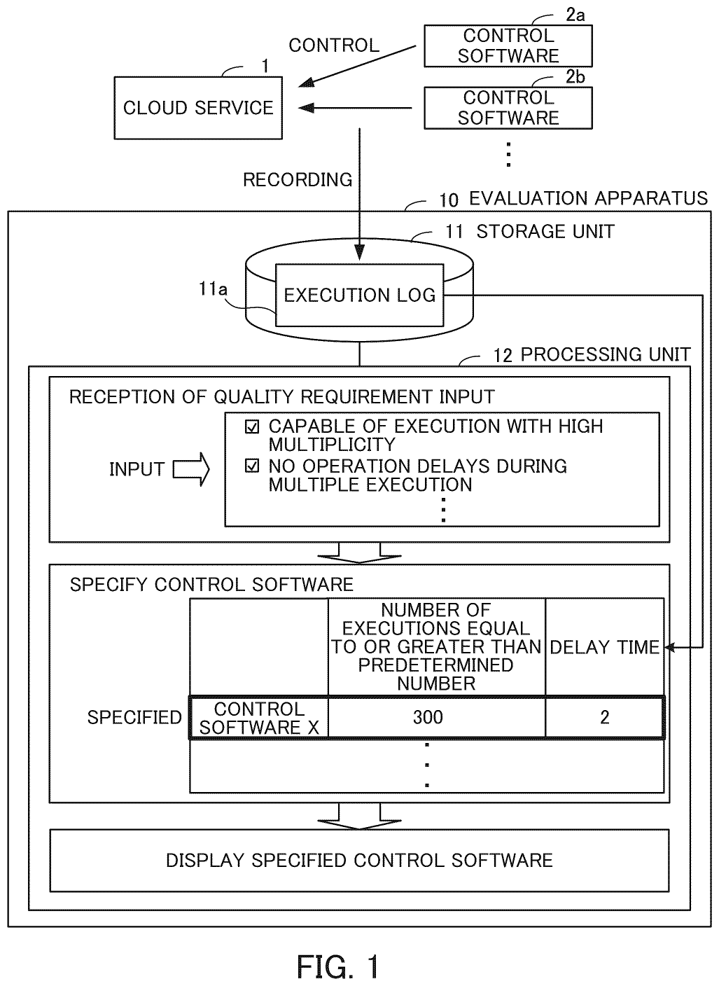

FIG. 1 depicts one example of an evaluation method according to a first embodiment. FIG. 1 depicts an evaluation apparatus 10 for implementing the evaluation method. As one example, the evaluation apparatus 10 may implement the evaluation method by executing an evaluation program. The evaluation apparatus 10 evaluates control software 2a, 2b, . . . that controls the cloud service 1.

The cloud service 1 is a service provided from a server via the Internet. As examples, the cloud service 1 is a service such as personnel management, customer management, and purchase management. The control software 2a, 2b, . . . control execution of the cloud service 1 in accordance with user inputs. For example, the control software 2a, 2b, . . . receives an input of a parameter for setting an operation at a target of control and requests a server that provides the cloud service 1 to perform processing in keeping with the received parameter. Note that the control software 2a, 2b, . . . may be executed by the evaluation apparatus 10 or may be executed by a computer aside from the evaluation apparatus 10.

The evaluation apparatus 10 includes a storage unit 11 and a processing unit 12. As examples, the storage unit 11 is a memory or a storage device included in the evaluation apparatus 10. As examples, the processing unit 12 is a processor or an arithmetic circuit included in the evaluation apparatus 10.

The storage unit 11 stores an execution log 11a. The execution log 11a records situations in which the control software 2a, 2b, . . . are used. As one example, the execution log 11a includes a start time, an end time, a processing content, and the like of a process that the control software 2a, 2b, . . . causes the cloud service 1 to execute. Based on the execution log 11a, the processing unit 12 presents control software that satisfies quality requirements requested by the user.

First, the processing unit 12 receives an input of quality requirements for the control software 2a, 2b, . . . . As one example, the processing unit 12 causes a terminal operated by the user to display quality requirements and check boxes corresponding to these quality requirements. The processing unit 12 receives an input of quality requirements corresponding to selected check boxes. In the example of FIG. 1, “capable of execution with high multiplicity”, which refers to an ability to control a predetermined number or higher of control operations of a cloud service 1 in parallel, is selected as a quality requirement. In the example in FIG. 1, “no operation delays during multiple execution”, which refers to a delay time when executing control operations of the cloud service 1 in parallel being equal to or less than a predetermined time, is also selected as a quality requirement.

Next, based on the execution log 11a, the processing unit 12 specifies control software whose usage record matches the quality requirements. As one example, based on the execution log 11a, the processing unit 12 counts the number of control operations of the cloud service 1 that are executed in parallel by the control software 2a, 2b, . . . . Here, the processing unit 12 refers to the start time and the end time of the processes executed by the cloud service 1 included in the execution log 11a, and counts the number of executions of processes that one control software has executed in parallel by the cloud service 1. The processing unit 12 counts the number of times the number of executions is equal to or greater than a predetermined number for each of the control software 2a, 2b, . . . .

As another example, the processing unit 12 calculates, based on the execution log 11a, a delay time when the control of the cloud service 1 is executed in parallel by the control software 2a, 2b, . . . . Here, the processing unit 12 refers to the execution log 11a and calculates, as the delay time for each of the control software 2a, 2b, . . . , a difference in execution time between a case where the cloud service 1 is caused to execute a plurality of processes in parallel and a case where the cloud service 1 is caused to execute one process.

The processing unit 12 then specifies control software whose number of executions and delay time satisfy the quality requirements. For example, the processing unit 12 specifies control software for which the number of times the number of executions has been equal to or greater than a predetermined number is equal to or greater than 1 and the delay time is equal to or less than a predetermined time. The processing unit 12 displays the specified control software. As one example, the processing unit 12 displays the name of the specified control software on the terminal operated by the user.

In this way, it is possible to present control software whose usage record matches the quality requirements requested by the user. This enables the user to appropriately select software for controlling the cloud service 1.

Note that the user may request the cloud service 1 to perform a plurality of processes in parallel. For this reason, based on the execution log 11a, the processing unit 12 counts the number of executions of control operations of the cloud service 1 executed in parallel by the control software 2a, 2b, . . . , and specifies control software whose number of executions matches the quality requirement. This makes it possible to present appropriate control software to a user who requests the cloud service 1 to perform a plurality of processes in parallel.

The processing unit 12 also calculates, based on the execution log 11a, a delay time when control operations of the cloud service 1 are executed in parallel by the control software 2a, 2b, . . . , and specifies control software whose delay time satisfies the quality requirement. By doing so, it is possible to present appropriate control software to a user who has requested that there is no delay when the cloud service 1 performs a plurality of processes in parallel.

Note that control software that is yet to be used may be included in the control software 2a, 2b, . . . . For this reason, the processing unit 12 may specify, out of the control software that satisfies the quality requirement but has no usage record, control software whose catalog specification satisfies the quality requirements, and display the specified control software. By doing so, it is possible to present control software that matches the quality requirements requested by the user but has no usage record.

The user may also request that the parameters of the cloud service 1 are easy to set. For this reason, the processing unit 12 may count the number of parameters to be inputted when the cloud service 1 is controlled by the control software 2a, 2b, . . . based on the execution log 11a, and specify control software whose number of parameters matches a quality requirement. This makes it possible to present appropriate control software to a user requests that the setting of parameters is easy.

The user may also request that the control software is easy to restore when the control software has ended abnormally. For this reason, the processing unit 12 may specify, based on the execution log 11a, the post-processing performed in a case where the control of the cloud service 1 by the control software 2a, 2b, . . . has ended abnormally, and specify control software whose post-processing satisfies the quality requirement. This makes it possible to present appropriate control software in keeping with the presence or absence of a flexible recovery method when the software ends abnormally.

The user may also request that it is easy to investigate problems when an error has occurred. For this reason, the processing unit 12 specifies, based on the execution log 11a, the type of log output function used by the control software 2a, 2b, . . . when controlling the cloud service 1 and specifies control software whose type of log output function matches the quality requirement. By doing so, it is possible to present appropriate control software in keeping with the amount of information used to investigate problems when an error has occurred.

The user may also request that the control software is capable of executing a predetermined process. For this reason, the processing unit 12 determines, based on the execution log 11a, whether the predetermined process is executed by each of the control software 2a, 2b, . . . and specifies control software for which the predetermined process is executed. As one example, when the cloud service 1 is caused to execute the plurality of processes by the control software 2a, 2b, . . . , the processing unit 12 receives, as the quality requirement, an input of a completion standby process of standing by for completion of each of a plurality of processes. Based on the execution log 11a, the processing unit 12 determines whether the completion standby process has been executed by the control software 2a, 2b, . . . . The processing unit 12 specifies the control software for which the completion standby process is executed. By doing so, it is possible to present appropriate control software to a user who requests software capable of executing the completion standby process.

As another example, the processing unit 12 receives, as a quality requirement, input of an execution status acquisition process for acquiring an execution status of processes executed by the cloud service 1 for the control software 2a, 2b, . . . . Based on the execution log 11a, the processing unit 12 determines whether the execution status acquisition process has been executed by the control software 2a, 2b, . . . . The processing unit 12 specifies control software that have executed the execution status acquisition process. By doing so, it is possible to present appropriate control software to a user who requests that control software is capable of executing the execution status acquisition process.

As another example, the processing unit 12 receives, as the quality requirement, an input of an error termination status acquisition process that acquires a status when a process executed by the cloud service 1 for the control software 2a, 2b, . . . has ended in error. Based on the execution log 11a, the processing unit 12 determines whether the control software 2a, 2b, . . . has executed the error termination status acquisition process. The processing unit 12 specifies control software that executes the error termination status acquisition process. By doing so, it is possible to present appropriate control software to a user who requests that control software is capable of executing the error termination status acquisition process.

As another example, the processing unit 12 receives, as the quality requirement, input of a forced termination process that forcibly terminates processing executed by the cloud service 1 for the control software 2a, 2b, . . . . Based on the execution log 11a, the processing unit 12 determines whether there has been execution of a forced termination process by the control software 2a, 2b, . . . . The processing unit 12 specifies control software for which the forced termination process has been executed. By doing so, it is possible to present appropriate control software to a user who requests that control software is capable of executing the forced termination process.

The cloud service 1 is periodically updated. The user may therefore request control software that tracks such updates. For this reason, the processing unit 12 may specify, based on the execution log 11a, the version of the cloud service 1 capable of being controlled by the control software 2a, 2b, . . . and specify control software where the version of the cloud service 1 capable of being controlled matches the quality requirement. By doing so, it is possible to present appropriate control software in keeping with the controllable version of the cloud service 1.

### Second Embodiment

In the second embodiment, a workflow control service is provided, and an appropriate connector is presented to a user based on a usage record of connectors for that workflow control service.

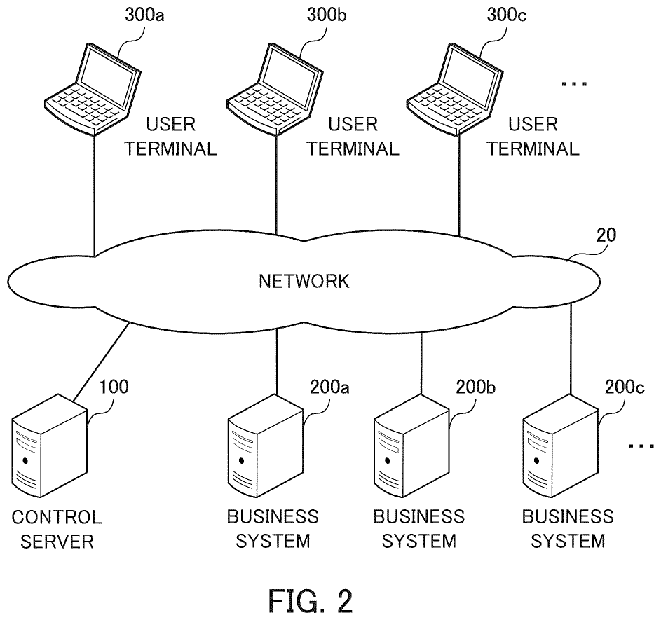

FIG. 2 depicts an example information processing system according to a second embodiment. In the information processing system according to the second embodiment, a control server 100, business systems 200a, 200b, 200c, . . . , and user terminals 300a, 300b, 300c, . . . are connected to a network 20.

The control server 100 is a server computer that provides a workflow control service. The control server 100 controls cloud services running on the business systems 200a, 200b, 200c, . . . using connectors. The control server 100 acquires, from the user terminals 300a, 300b, 300c, . . . , a parameter for setting an operation content (as examples, GET and POST) for a cloud service being controlled. The control server 100 uses a connector to request a business system on which the cloud service being controlled is running to perform processing corresponding to the acquired parameter. The control server 100 analyzes demand forecasts of personnel, production volume, delivery volume, and the like based on the information acquired from the business systems 200a, 200b, 200c, . . . , and notifies the user terminals 300a, 300b, 300c, . . . of the analysis results.

The business systems 200a, 200b, 200c, . . . are server computers that provide cloud services such as personnel management, customer management, and purchase management. The business systems 200a, 200b, 200c, . . . execute processing in keeping with a request from the control server 100 and notify the control server 100 of the processing result.

The user terminals 300a, 300b, 300c, . . . are computers operated by users who use the workflow control service. The user terminals 300a, 300b, 300c, . . . receive an input of parameters and transmit the inputted parameters to a connector of the control server 100. The user terminals 300a, 300b, 300c, . . . also display the analysis results notified from the control server 100.

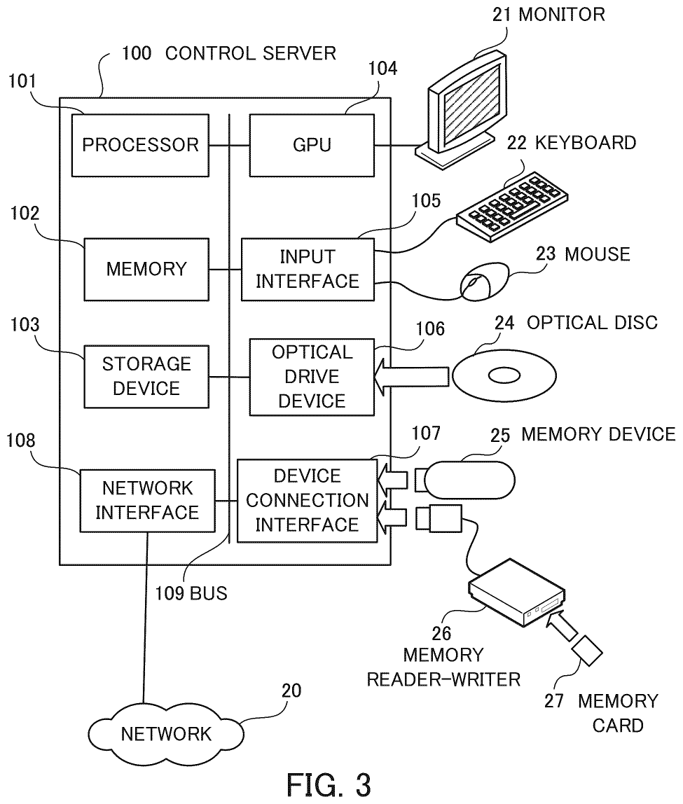

FIG. 3 depicts example hardware of a control server. The entire control server 100 is controlled by a processor 101. A memory 102 and a plurality of peripheral devices are connected to the processor 101 via a bus 109. The processor 101 may be a multiprocessor system including a plurality of processors. A group of processors in a multiprocessor system may be referred to as the “processor 101”. The processor 101 may also be referred to as “processor circuitry”. Each of such plurality of processors may execute some or all of the plurality of processes to be executed by the control server 100. When there are a plurality of related processes, two or more processes out of the plurality of processes may be executed by different processors. As examples, the processor 101 is a central processing unit (CPU), a micro processing unit (MPU), or a digital signal processor (DSP). At least some of the functions to be realized by the processor 101 executing a program may be realized by an electronic circuit such as an application specific integrated circuit (ASIC) or a programmable logic device (PLD).

The memory 102 is used as a main storage device of the control server 100. The memory 102 temporarily stores at least part of an operating system (OS) program and application programs to be executed by the processor 101. The memory 102 also stores various data used for processing by the processor 101. As one example, a volatile semiconductor storage device, such as a random access memory (RAM) is used as the memory 102.

The peripheral devices connected to the bus 109 include a storage device 103, a graphics processing unit (GPU) 104, an input interface 105, an optical drive device 106, a device connection interface 107, and a network interface 108.

The storage device 103 electrically or magnetically writes and reads data to and from an internally equipped recording medium. The storage device 103 is used as an auxiliary storage device of the control server 100. The storage device 103 stores OS programs, application programs, and various data. Note that a hard disk drive (HDD) or a solid state drive (SSD) may be used as examples of the storage device 103.

The GPU 104 is an arithmetic unit that performs image processing. The GPU 104 is one example of a graphics controller. A monitor 21 is connected to the GPU 104. The GPU 104 displays an image on the screen of the monitor 21 in accordance with an instruction from the processor 101. Examples of the monitor 21 include a display device that uses organic electro luminescence (EL) and a liquid crystal display device.

A keyboard 22 and a mouse 23 are connected to the input interface 105. The input interface 105 transmits signals sent from the keyboard 22 and the mouse 23 to the processor 101. Note that the mouse 23 is one example of a pointing device, and other pointing devices may be used. Examples of other pointing devices include a touch panel, a tablet, a touch pad, and a track ball.

The optical drive device 106 uses laser light or the like to read data recorded on the optical disc 24 or to write data onto the optical disc 24. The optical disc 24 is a portable recording medium on which data is recorded so as to be readable using reflected light. The optical disc 24 may be a digital versatile disc (DVD), a DVD-RAM, a compact disc read only memory (CD-ROM), a CD-recordable (CD-R), CD-rewritable (CD-RW), or the like.

The device connection interface 107 is a communication interface for connecting peripheral devices to the control server 100. As examples, a memory device 25 and a memory reader-writer 26 may be connected to the device connection interface 107. The memory device 25 is a recording medium equipped with a communication function for communicating with the device connection interface 107. The memory reader-writer 26 is a device that writes data onto a memory card 27 or reads data from the memory card 27. The memory card 27 is a card-type recording medium.

The network interface 108 is connected to the network 20. The network interface 108 transmits and receives data to and from another computer or communication device via the network 20. The network interface 108 is a wired communication interface connected via a cable to a wired communication device, such as a switch or a router. The network interface 108 may also be a wireless communication interface connected by radio waves to a wireless communication device, such as a base station or an access point, to enable communication.

The control server 100 realizes the processing functions of the second embodiment using hardware like that described above. The business systems 200a, 200b, 200c, . . . and the user terminals 300a, 300b, 300c, . . . may also be realized by similar hardware to the control server 100. The evaluation apparatus 10 described in the first embodiment may also be implemented by similar hardware to the control server 100.

The control server 100 realizes the processing functions of the second embodiment by executing a program recorded on a computer-readable recording medium, for example. The program in which the processing content to be executed by the control server 100 is written may be recorded on various recording media. For example, a program to be executed by the control server 100 may be stored in the storage device 103. The processor 101 loads at least part of the program in the storage device 103 into the memory 102 and executes the program. The program to be executed by the control server 100 may be recorded on a portable recording medium, such as the optical disc 24, the memory device 25, or the memory card 27. A program stored on a portable recording medium becomes executable after being installed in the storage device 103 under the control of the processor 101, for example. Alternatively, the processor 101 may read the program directly from the portable recording medium and execute the program.

Next, a workflow control service will be described.

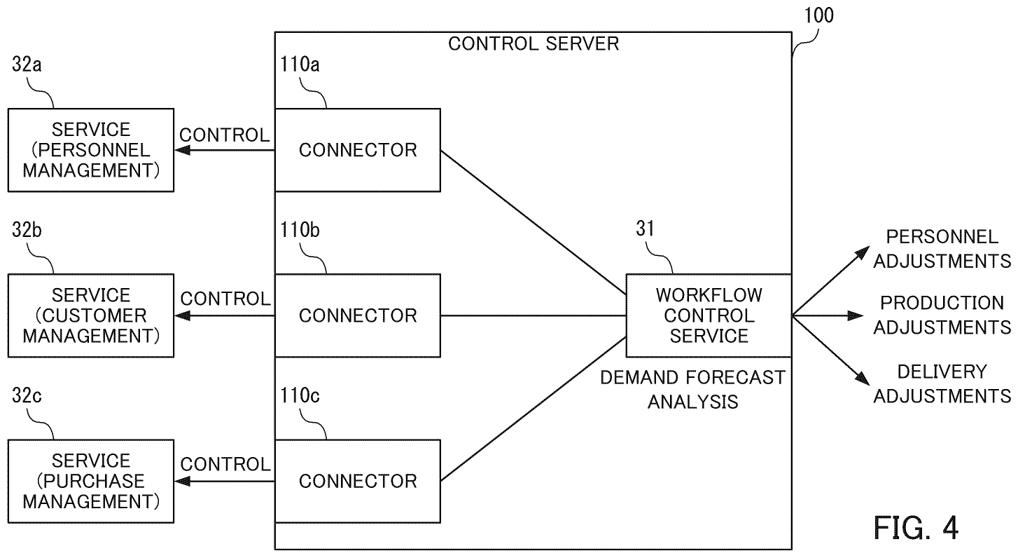

FIG. 4 depicts one example of a workflow control service. The workflow control service 31 is a service provided by the control server 100. The user of the workflow control service 31 controls the services 32a, 32b, and 32c via the connectors 110a, 110b, and 110c.

The connector 110a is a connector that controls the service 32a. The service 32a is a cloud service for personnel management. When the connector 110a has received a setting of parameters for the service 32a by the user terminals 300a, 300b, 300c, . . . , the connector 110a requests the business system that provides the service 32a to perform processing in keeping with the set parameters.

The connector 110b is a connector for controlling the service 32b. The service 32b is a cloud service for customer management. When the connector 110b has received a setting of parameters for the service 32b by the user terminals 300a, 300b, 300c, . . . , the connector 110b requests the business system that provides the service 32b to perform processing in keeping with the set parameters.

The connector 110c is a connector for controlling the service 32c. The service 32c is a cloud service for purchase management. When the connector 110c has received a setting of parameters for the service 32c by the user terminals 300a, 300b, 300c, . . . , the connector 110c requests the business system that provides the service 32c to perform processing in keeping with the set parameters.

In the workflow control service 31, the control server 100 analyzes the processing results of the services 32a, 32b, and 32c, and calculates demand forecasts for personnel, production volume, delivery volume, and the like. The control server 100 transmits the analysis results to the user terminals 300a, 300b, 300c, . . . . The user then makes personnel adjustments, production adjustments, and delivery adjustments based on the analysis results.

In this way, the control server 100 provides the workflow control service 31. When a plurality of connectors correspond to each cloud service, the user of the workflow control service 31 selects a connector to be used for a cloud service. Since each connector has different functions, it is desirable for a user to select a connector with desired functions. For this reason, in the second embodiment, the control server 100 evaluates the quality of each connector based on the usage record of that connector, and presents connectors that satisfy the quality requirements requested by the user.

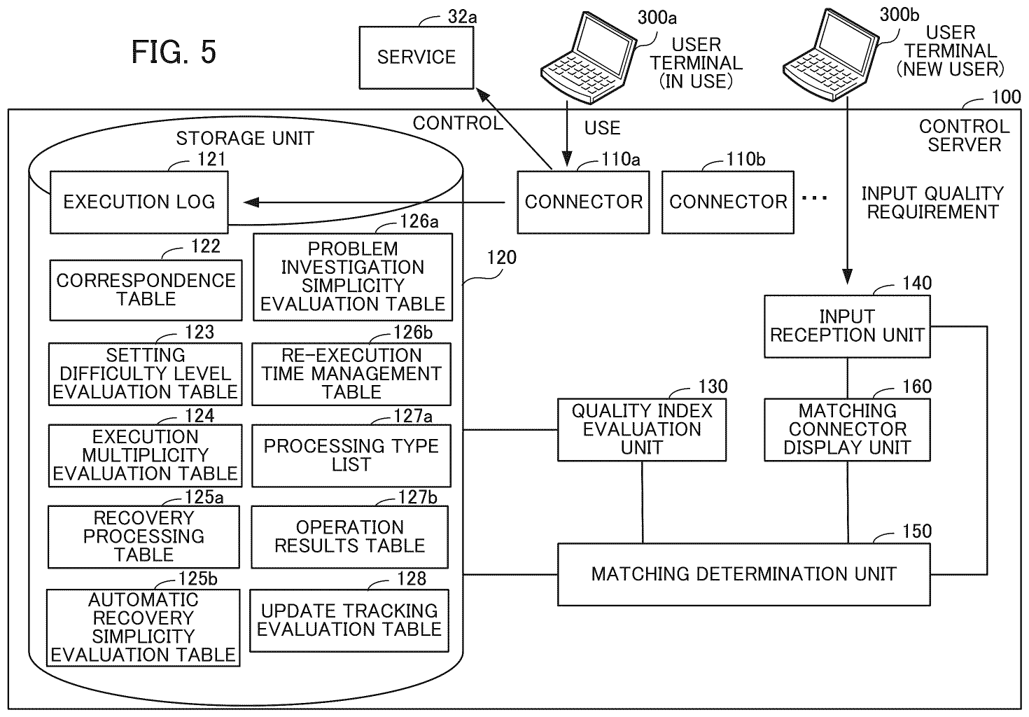

FIG. 5 is a block diagram depicting a function where a control server presents connectors that satisfy quality requirements based on usage records. The control server 100 includes a storage unit 120, a quality index evaluation unit 130, an input reception unit 140, a matching determination unit 150, and a matching connector display unit 160.

The storage unit 120 stores an execution log 121, a correspondence table 122, a setting difficulty level evaluation table 123, an execution multiplicity evaluation table 124, a recovery processing table 125a, and an automatic recovery simplicity evaluation table 125b. The storage unit 120 also stores a problem investigation simplicity evaluation table 126a, a re-execution time management table 126b, a processing type list 127a, an operation results table 127b, and an update tracking evaluation table 128.

The execution log 121 records situations in which the connectors 110a, 110b, . . . are used in the control server 100. As one example, when the user terminal 300a that is using the workflow control service 31 controls the workflow control service 31 using the connector 110a, the execution log 121 records the setting content made by the user terminal 300a, the processing content that the connector 110a has the workflow control service 31 execute, and the like. As examples, setting screens before and after the setting of parameters, a processing content, a processing start time, and a processing end time are recorded in the execution log 121.

The correspondence table 122 is a table indicating cloud services corresponding to the connectors 110a, 110b, . . . . The setting difficulty level evaluation table 123 is a table in which information for evaluating the setting difficulty levels of the connectors 110a, 110b, . . . is recorded. The execution multiplicity evaluation table 124 is a table in which information for evaluating performance (or execution multiplicity) when the connectors 110a, 110b, . . . have the cloud services to be controlled execute processing in parallel (here referred to as “multiple execution”) is recorded.

The recovery processing table 125a and the automatic recovery simplicity evaluation table 125b are used to evaluate the simplicity of automatic recovery when the connectors 110a, 110b, . . . have ended abnormally. The recovery processing table 125a is a table in which the recovery processing when the connectors 110a, 110b, . . . have abnormally ended is recorded. The automatic recovery simplicity evaluation table 125b is a table in which information for evaluating the simplicity of automatic recovery of the connectors 110a, 110b, . . . is recorded.

The problem investigation simplicity evaluation table 126a and the re-execution time management table 126b are used to evaluate the simplicity of investigating a problem when an error has occurred at the connectors 110a, 110b, . . . . The problem investigation simplicity evaluation table 126a is a table in which information for evaluating the ease (or “simplicity”) of investigating problems at the connectors 110a, 110b, . . . is recorded. The re-execution time management table 126b is a table in which an error time at which an error occurred at the connectors 110a, 110b, . . . and the restart time are recorded.

The processing type list 127a and the operation results table 127b are used to evaluate the flexibility of control of linked services by the connectors 110a, 110b, . . . . The processing type list 127a is a table indicating types of processing. The operation results table 127b is a table in which execution results of processes indicated in the processing type list 127a by the connectors 110a, 110b, . . . are recorded. The update tracking evaluation table 128 is a table in which information for evaluating whether the connectors 110a, 110b, . . . track updating of a cloud service being controlled is recorded.

The quality index evaluation unit 130 evaluates the setting difficulty level, the execution multiplicity, the automatic recovery simplicity, the problem investigation simplicity, the flexibility of control of linked services, and ability to track updates of controlled objects of the connectors 110a, 110b, . . . . In the evaluation of the setting difficulty level, the quality index evaluation unit 130 evaluates the number of parameters and the setting time of the connectors 110a, 110b, . . . based on the execution log 121, and records the number of parameters and the setting time in the setting difficulty level evaluation table 123. The quality index evaluation unit 130 also records the catalog specifications of the number of parameters and the setting time of the connectors 110a, 110b, . . . in the setting difficulty level evaluation table 123.

In the evaluation of execution multiplicity, the quality index evaluation unit 130 specifies whether execution multiplicity of the connectors 110a, 110b, . . . is possible based on the execution log 121, calculates the operation delay time when multiple execution is performed, and records the result in the execution multiplicity evaluation table 124. The quality index evaluation unit 130 also records, in the execution multiplicity evaluation table 124, the catalog specifications of whether execution multiplicity is available for the connectors 110a, 110b, . . . and the operation delay time during multiple execution.

In the evaluation of the simplicity of automatic recovery, the quality index evaluation unit 130 records, in the recovery processing table 125a, the recovery process when the connectors 110a, 110b, . . . have ended abnormally based on the execution log 121. Based on the recovery processing table 125a, the quality index evaluation unit 130 then records, in the automatic recovery simplicity evaluation table 125b, the results of the connectors 110a, 110b, . . . executing functions related to automatic recovery. The quality index evaluation unit 130 also records the catalog specifications of whether the connectors 110a, 110b, . . . have a function related to automatic recovery in the automatic recovery simplicity evaluation table 125b.

In the evaluation of the simplicity of problem investigation, the quality index evaluation unit 130 records, based on the execution log 121, a usage record of a log output application programming interface (API) performed by the connectors 110a, 110b, . . . in the problem investigation simplicity evaluation table 126a. The quality index evaluation unit 130 also records catalog specifications of availability of a log output API by the connectors 110a, 110b, . . . in the problem investigation simplicity evaluation table 126a. The quality index evaluation unit 130 also records, based on the execution log 121, the time at which an error occurred at the connectors 110a, 110b, . . . and the restart time in the re-execution time management table 126b. Based on the re-execution time management table 126b, the quality index evaluation unit 130 then records the time from the occurrence of an error to a restart in the connectors 110a, 110b, . . . in the problem investigation simplicity evaluation table 126a.

In the evaluation of flexibility of control of linked services, the quality index evaluation unit 130 records the execution results of processes indicated in the processing type list 127a by the connectors 110a, 110b, . . . in the operation results table 127b based on the execution log 121. The quality index evaluation unit 130 records, in the operation results table 127b, catalog specifications indicating whether execution of the processes indicated in the processing type list 127a is possible by the connectors 110a, 110b, . . . .

In the evaluation of tracking of updates at a controlled object, the quality index evaluation unit 130 records, based on the execution log 121, the execution results of processing for each version of the cloud service being controlled by the connectors 110a, 110b, . . . in the update tracking evaluation table 128. The quality index evaluation unit 130 also records, in the update tracking evaluation table 128, catalog specifications indicating whether execution of processing is possible for each version of the cloud service being controlled by the connectors 110a, 110b, . . . .

The input reception unit 140 receives an input of a cloud service being controlled and quality requirements from a user terminal (for example, the user terminal 300b) of a user who is newly using the workflow control service 31. The matching determination unit 150 determines a connector whose usage record or catalog specification matches the quality requirements out of the connectors corresponding to the cloud service for which an input has been received by the input reception unit 140. The matching determination unit 150 refers to the correspondence table 122 and extracts connectors corresponding to the cloud service for which an input has been received. The matching determination unit 150 then refers to the tables stored in the storage unit 120 and determines, out of the extracted connectors, a connector whose record values or catalog specification match the quality requirements.

The matching connector display unit 160 causes the user terminal 300b to display connectors whose usage records match the quality requirements and connectors whose catalog specifications match the quality requirements, which have been specified by the matching determination unit 150.

Note that the lines connecting the elements depicted in FIG. 5 indicate only some of the communication paths, and it is also possible to set communication paths aside from the communication paths that have been depicted. The functions of the respective elements depicted in FIG. 5 may be realized by causing a computer to execute program modules corresponding to the elements, for example.

Next, information stored in the storage unit 120 will be described in more detail.

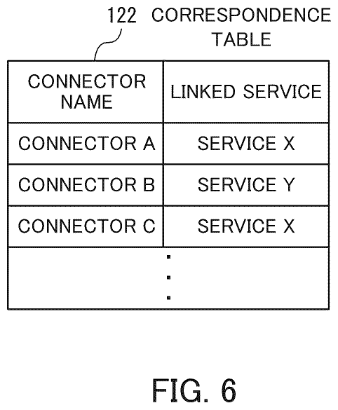

FIG. 6 depicts one example of a correspondence table. The correspondence table 122 is a table indicating cloud services corresponding to the connectors 110a, 110b, . . . . In the correspondence table 122, cloud services to be controlled (or “linked services”) are set in association with the names (or “connector names”) of the connectors 110a, 110b, . . . .

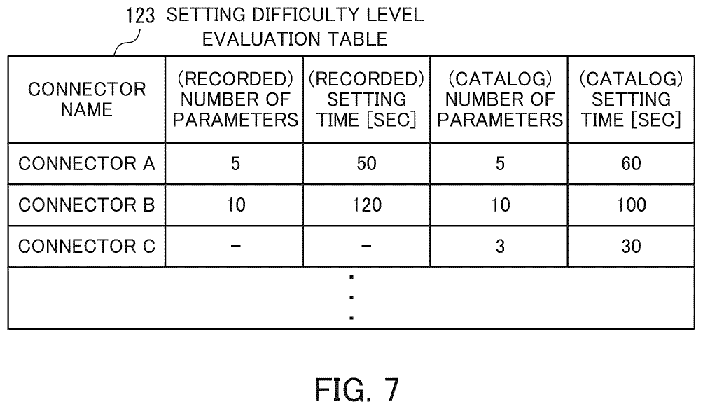

FIG. 7 depicts one example of a setting difficulty level evaluation table. A record for each connector is registered in the setting difficulty level evaluation table 123. A connector name, a (recorded) number of parameters, (recorded) setting time (in seconds), a (catalog) number of parameters, and a (catalog) setting time (in seconds) are set in each record. Note that the symbol “-” is set for the (recorded) number of parameters and the (recorded) setting time (in seconds) corresponding to a connector with no corresponding usage record. The connector name is the name of the connector.

The (recorded) number of parameters is the number of parameters of a connector based on a usage record. The quality index evaluation unit 130 counts the number of parameters from the difference between the setting screens before and after the parameter setting based on the execution log 121, and stores the counted number of parameters in the (recorded) number of parameters. The (recorded) setting time (in seconds) is a setting time for the parameters of the connector based on actual usage. The quality index evaluation unit 130 calculates the setting time from the difference between the setting start time of the parameters and the setting end time of the parameters based on the execution log 121, and stores the calculated setting time in the (recorded) setting time (in seconds). The (catalog) number of parameters is the catalog specification of the number of parameters of a connector. The (catalog) setting time (in seconds) is a catalog specification of the setting time of the parameters of a connector.

Quality requirements relating to the setting difficulty level of a connector include a small number of parameters and a short parameter setting time. When the value of the (recorded) number of parameters is equal to or less than a threshold, the matching determination unit 150 determines that the recorded value satisfies the quality requirement that the number of parameters is small for the corresponding connector. When the value of the (catalog) number of parameters is equal to or less than the threshold, the matching determination unit 150 determines that the catalog specification satisfies the quality requirement that the number of parameters is small for the corresponding connector.

When the value of the (recorded) setting time (in seconds) is equal to or less than a threshold, the matching determination unit 150 determines that the recorded value satisfies the quality requirement that the parameter setting time is short for the corresponding connector. When the value of the (catalog) setting time (in seconds) is equal to or less than the threshold, the matching determination unit 150 determines that the catalog specification satisfies the quality requirement that the parameter setting time is short for the corresponding connector.

In this way, it is possible to specify a connector with a small number of parameters or a connector with a short parameter setting time. By presenting specified connectors to the user, it is possible for a user who requests that the setting of parameters is easy to select an appropriate connector.

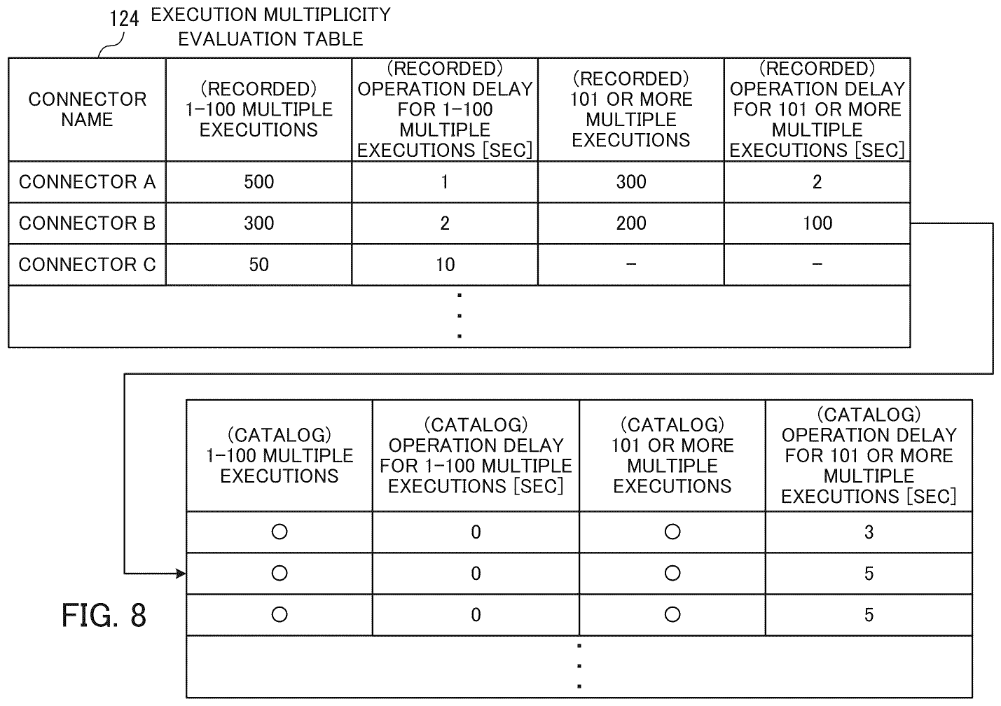

FIG. 8 depicts one example of an execution multiplicity evaluation table. A record for each connector is registered in the execution multiplicity evaluation table 124. In each record, a connector name, (recorded) 1 to 100 multiple executions, (recorded) operation delay for 1 to 100 multiple executions (in seconds), (recorded) 101 or more multiple executions, and (recorded) operation delay for 101 or more multiple executions (in seconds) are set. In each record, (catalog) 1 to 100 multiple executions, (catalog) operation delay for 1 to 100 multiple executions (in seconds), (catalog) 101 or more multiple executions, and (catalog) operation delay for 101 or more multiple executions (in seconds) are also set.

Note that “-” is set for (recorded) 1 to 100 multiple executions, (recorded) operation delay for 1 to 100 multiple executions (in seconds), (recorded) 101 or more multiple executions, and the operation delay for 101 or more multiple executions (in seconds) corresponding to a connector with no corresponding results from actual use.

The connector name is the name of a connector. (recorded) 1 to 100 multiple executions are results that were recorded when the connector performed 1 to 100 processes through multiplexing. Based on the execution log 121, the quality index evaluation unit 130 counts the processes that are multiplexed, and stores the number of times the number of counted processes was 1 to 100 in the (recorded) 1 to 100 multiple executions column.

The (recorded) operation delay for 1 to 100 multiple executions (in seconds) is an operation delay time when the connector performs 1 to 100 processes through multiplexing, which is calculated based on results of actual use. Based on the execution log 121, the quality index evaluation unit 130 stores the difference between the processing time in a case where 1 to 100 processes are multiplexed and the processing time in a case where one process is executed in the (recorded) operation delay for 1 to 100 multiple executions (in seconds) column.

The (recorded) 101 or more multiple executions value is a record of when the connector executed 101 or more processes through multiplexing. Based on the execution log 121, the quality index evaluation unit 130 counts the number of processes that are multiplexed, and stores the number of times that the number of counted processes is 101 or more in the (recorded) 101 or more multiple executions column.

The (recorded) operation delay for 101 or more multiple executions (in seconds) value is an operation delay time when the connector performs 101 or more processes through multiplexing, which is calculated based on results of actual use. Based on the execution log 121, the quality index evaluation unit 130 stores the difference between the processing time in a case where 101 or more processes are multiplexed and the processing time in a case where one process is executed in the (recorded) operation delay for 101 or more multiple executions (in seconds) column.

The (catalog) 1 to 100 multiple executions value is a catalog specification indicating whether the connector is capable of executing 1 to 100 processes by multiplexing. In the (catalog) 1 to 100 multiple executions column, “◯” indicates that the connector is capable of executing 1 to 100 processes through multiplexing, while “X” indicates that the connector is not capable of executing 1 to 100 processes by multiplexing. The (catalog) operation delay for 1 to 100 multiple executions (in seconds) is a catalog specification of an operation delay time when the connector performs 1 to 100 processes through multiplexing.

The (catalog) 101 or more multiple executions value is a catalog specification indicating whether the connector is capable of executing 101 or more processes through multiplexing. In the (catalog) 101 or more multiple executions column, “◯” indicates that a connector is capable for executing 101 or more processes through multiplexing, while “X” indicates that the connector is not capable of executing 101 or more processes through multiplexing. The (catalog) operation delay for 101 or more multiple executions (in seconds) is a catalog specification of an operation delay time when the connector performs 101 or more processes through multiplexing.

Quality requirements relating to the performance of a connector during multiple execution include the ability to execute at high multiplicity and the absence of operational delays during multiple executions. When the value of the (recorded) 101 or more multiple executions is 1 or more (that is, in a case where there is an actual record of multiple execution of 101 or more processes), the matching determination unit 150 determines that the corresponding connector satisfies a quality requirement of actual records indicating that execution at the high multiplicity is possible. When “◯” is set in the (catalog) 101 or more multiple executions column, the matching determination unit 150 determines that the corresponding connector satisfies a quality requirement of the catalog specification indicating that execution at high multiplicity is possible.

In addition, when the value of the (recorded) operation delay for 1 to 100 multiple executions (in seconds) and the value of the (recorded) operation delay for 101 or more multiple executions (in seconds) are equal to or less than a threshold, the matching determination unit 150 determines that the corresponding connector satisfies a quality requirement of actual records indicating that no operation delay occurs during multiple execution. When the value of the (catalog) operation delay for 1 to 100 multiple executions (in seconds) and the value of the (catalog) operation delay for 101 or more multiple executions (in seconds) are equal to or less than the threshold, the matching determination unit 150 determines that the corresponding connector satisfies a quality requirement of the catalog specification indicating that no operation delay occurs during multiple execution.

In this way, it is possible to specify connectors capable of executing with high multiplicity and connectors that do not cause an operation delay during multiple execution. By presenting the specified connectors to the user, it is possible to enable a user who requests high performance by a connector during multiple execution to select an appropriate connector.

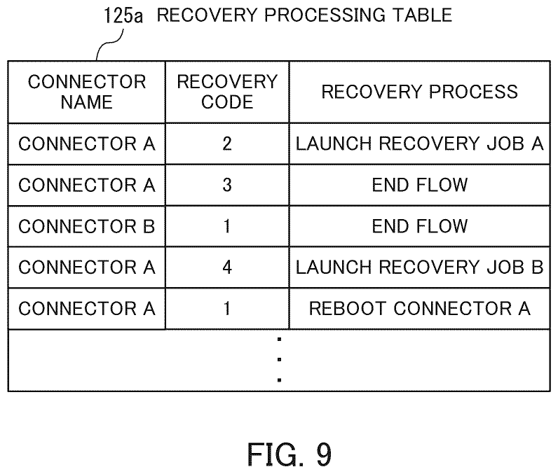

FIG. 9 depicts one example of a recovery processing table. In the recovery processing table 125a, a record is registered for each abnormal termination of a connector that has occurred. A connector name, a recovery code, and a recovery process are set in each record. The connector name is the name of the connector that terminated abnormally. The recovery code is a code indicating a situation when recovery was performed following an abnormal termination. The recovery processing is the post-processing performed after abnormal termination. Based on the execution log 121, the quality index evaluation unit 130 records the connector name, the recovery code, and the recovery process in the recovery processing table 125a when a connector has abnormally terminated.

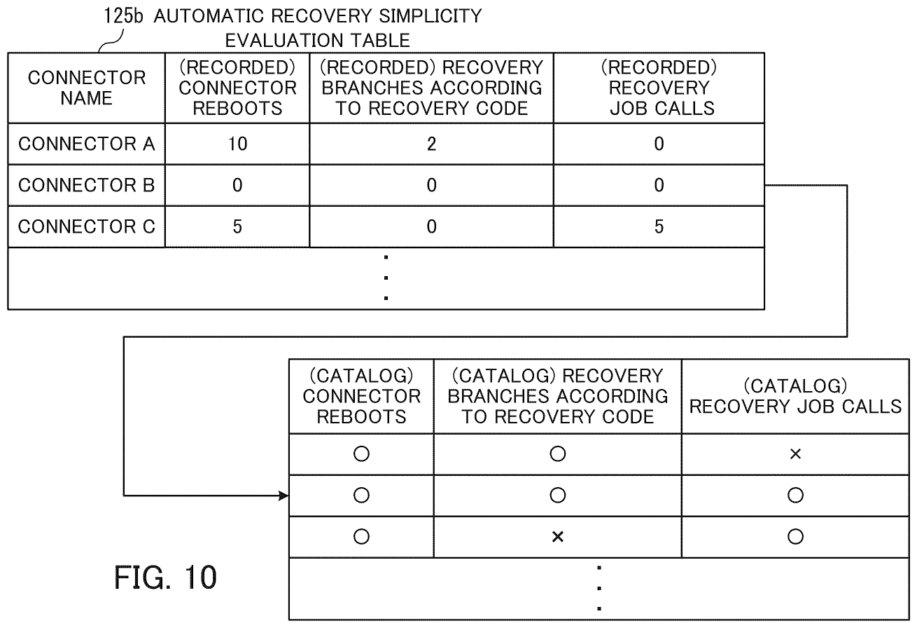

FIG. 10 depicts one example of an automatic recovery simplicity evaluation table. A record for each connector is registered in the automatic recovery simplicity evaluation table 125b. A connector name, (recorded) connector reboots, (recorded) recovery branches according to recovery code, and (recorded) recovery job calls are set in each record. (Catalog) connector reboots, (catalog) recovery branches according to recovery code, and (catalog) recovery job calls are also set in each record.

The connector name is the name of the connector. The (recorded) connector reboots is the number of times the connector has executed a rebooting process which is counted based on the usage record. Based on the execution log 121, the quality index evaluation unit 130 counts the number of times the corresponding connector has executed the rebooting process, and stores the counted number of times in the (recorded) connector reboots column.

The (recorded) recovery branches according to recovery code value is the number of types of post-processing for recovery codes of a connector that are counted based on the usage record. The quality index evaluation unit 130 counts the combinations of recovery codes and recovery processes registered in the recovery processing table 125a for the corresponding connector, and stores the counted types in the (recorded) recovery branches according to recovery code column.

The (recorded) recovery job calls is a record of recovery job call processing performed by the connector. Based on the execution log 121, the quality index evaluation unit 130 counts the number of times the corresponding connector has executed a recovery job call process, and stores the counted number of times in the (recorded) recovery job calls column.

The (catalog) connector reboots value is a catalog specification indicating whether the connector is equipped with a rebooting function. The (catalog) recovery branches according to recovery code value is a catalog specification indicating whether the connector is equipped with a function of branching the recovery process according to the recovery code. The (catalog) recovery job calls value is a catalog specification indicating whether the connector is equipped with a recovery job call function. In the (catalog) connector reboots, the (catalog) recovery branches according to recovery code, and (catalog) recovery job calls columns, “◯” indicates that the respective functions are provided, while “X” indicates that the respective functions are not provided.

Quality requirements related to the ease of automatic recovery of a connector include an ability to recover through a rebooting process, an ability to recover by branching the recovery method according to a recovery code, and an ability to recover by calling a recovery job when an abnormality has occurred. When the value of (recorded) connector reboots is 1 or more (that is, when there is an actual result of a connector executing the rebooting process), the matching determination unit 150 determines that the corresponding connector satisfies a quality requirement of actual results indicating that recovery by a rebooting process is possible. When “◯” is set in the (catalog) connector reboots column, the matching determination unit 150 determines that the corresponding connector satisfies a quality requirement of the catalog specification indicating that recovery by a rebooting process is possible.

When the value of the (recorded) recovery branches according to recovery code is 2 or more, the matching determination unit 150 determines that the corresponding connector satisfies a quality requirement of actual results indicating that recovery by branching the recovery method according to the recovery code is possible. That is, when there are actual results of execution of a plurality of recovery processes according to recovery codes, the matching determination unit 150 determines that the corresponding connector satisfies the quality requirement of actual results indicating that recovery by branching the recovery method according to the recovery code is possible. When “◯” is set in the (catalog) recovery branches according to recovery code, the matching determination unit 150 determines that the corresponding connector satisfies a quality requirement of the catalog specification indicating that recovery by branching the recovery method according to the recovery code is possible.

When the value of the (recorded) recovery job calls is 1 or more, the matching determination unit 150 determines that the corresponding connector satisfies a quality requirement of actual results indicating that recovery by a recovery job call when an abnormality occurs is possible. That is, when there is an actual record of execution of a call process for a recovery job, the matching determination unit 150 determines that the corresponding connector satisfies a quality requirement of actual records indicating that recovery by a recovery job call when an abnormality occurs is possible. When “◯” is set in the (catalog) recovery job calls column, the matching determination unit 150 determines that corresponding connector satisfies a quality requirement of the catalog specification indicating that recovery by a recovery job call when an abnormality occurs is possible.

In this way, it is possible to specify connectors capable of recovery by a rebooting process, branching the recovery method according to the recovery code, and/or calling of a recovery job. By presenting the specified connectors to the user, it is possible to enable a user who requests that automatic recovery of the connector is easy to select an appropriate connector.

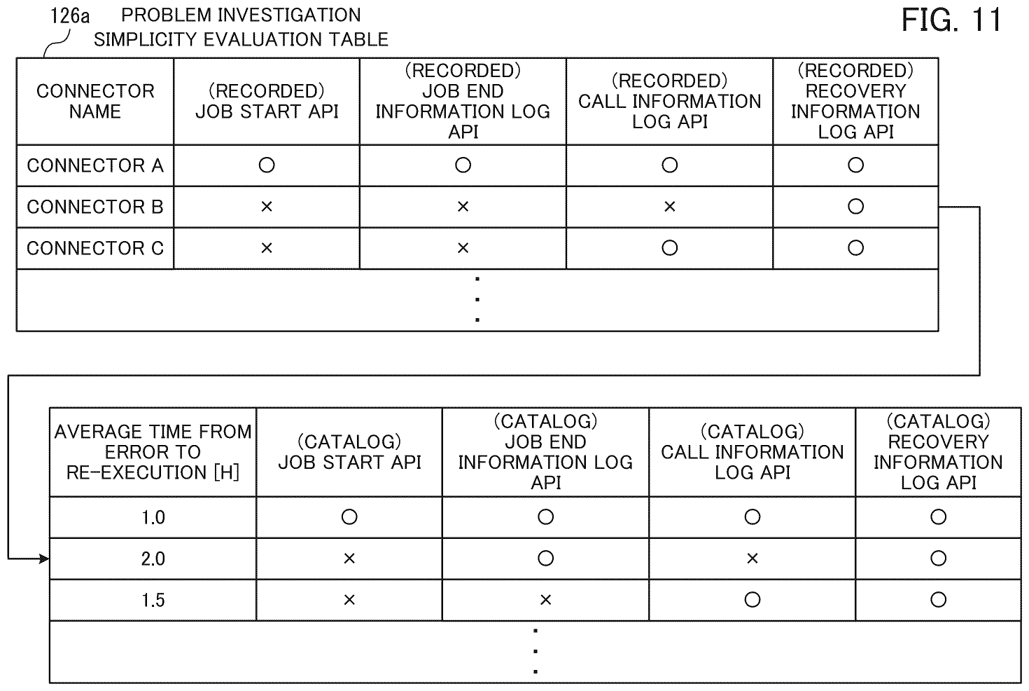

FIG. 11 depicts one example of a problem investigation simplicity evaluation table. A record for each connector is registered in the problem investigation simplicity evaluation table 126a. A connector name, (recorded) job start API, (recorded) job end information log API, (recorded) call information log API, (recorded) recovery information log API, and an average time from an error to re-execution (H) are set in each record. A (catalog) (catalog) job end information log API, job start API, (catalog) call information log API, and (catalog) recovery information log API are also set in each record.

The connector name is the name of a connector. The (recorded) job start API is a usage record of a job start API of that connector. The (recorded) job end information log API is a usage record of a job end information log API of that connector. The (recorded) call information log API is a usage record of a call information log API of that connector. The (recorded) recovery information log API is a usage record of a recovery information log API of that connector. The quality index evaluation unit 130 determines whether usage of each API of a connector has been recorded based on the execution log 121. The quality index evaluation unit 130 sets “◯” in columns of APIs for which usage by that connector has been recorded, and sets “X” in columns of APIs for which usage by that connector has not been recorded.

The average time from an error to re-execution (H) is an average time from an error termination to a restart of the connector based on the usage record. Based on the re-execution time management table 126b, the quality index evaluation unit 130 calculates the average of the time from error termination to a restart of the corresponding connector and stores the average in the average time from an error to re-execution (H) column.

The (catalog) job start API is a catalog specification of whether a connector is capable of using the job start API. The (catalog) job end information log API is a catalog specification of whether a connector is capable of using the job end information log API. The (catalog) call information log API is a catalog specification of whether a connector is capable of using the call information log API. The (catalog) recovery information log API is a catalog specification of whether a connector is capable of using the recovery information log API. In the (catalog) job start API column, the (catalog) job end information log API column, the (catalog) call information log API column, and the (catalog) recovery information log API column, “◯” indicates that a connector is capable of using that API, while “X” indicates that a connector is not capable of using that API.

As quality requirements relating to the simplicity of investigating problems at a connector, an ability to use each API out of the job start API, the job end information log API, the call information log API, and the recovery information log API may be used. When “◯” is set in the (recorded) job start API column, the matching determination unit 150 determines that the corresponding connector satisfies a quality requirement of actual records indicating that the job start API is available. When “◯” is set in the (catalog) job start API column, the matching determination unit 150 determines that the corresponding connector satisfies a quality requirement of the catalog specification indicating that the job start API is available.

When “◯” is set in the (recorded) job end information log API column, the matching determination unit 150 determines that the corresponding connector satisfies a quality requirement of actual records indicating that the job end information log API is available. When “◯” is set in the (catalog) job end information log API column, the matching determination unit 150 determines that the corresponding connector satisfies a quality requirement of the catalog specification indicating that the job end information log API is available.

When “◯” is set in the (recorded) call information log API column, the matching determination unit 150 determines that the corresponding connector satisfies a quality requirement of actual records indicating that the call information log API is available. When “◯” is set in the (catalog) call information log API column, the matching determination unit 150 determines that the corresponding connector satisfies a quality requirement of the catalog specification indicating that the call information log API is available.

When “◯” is set in the (recorded) recovery information log API column, the matching determination unit 150 determines that the corresponding connector satisfies a quality requirement of actual records indicating that the recovery information log API is available. When “◯” is set in the (catalog) recovery information log API, the matching determination unit 150 determines that the corresponding connector satisfies a quality requirement of the catalog specification indicating that the recovery information log API is available.

In this way, it is possible to specify connectors capable of using respective APIs out of the job start API, the job end information log API, the call information log API, and the recovery information log API. By presenting the specified connectors to the user, it is possible for a user who requests predetermined information for investigating problems when an error has occurred or a user who requests a large amount of information for investigating problems when an error occurs to select an appropriate connector.

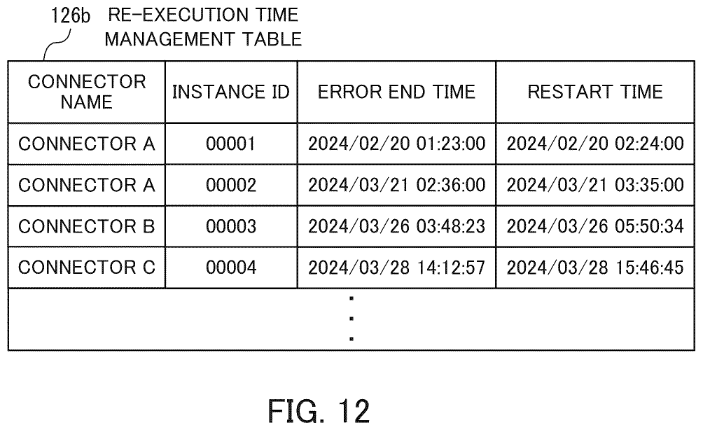

FIG. 12 depicts one example of a re-execution time management table. A record for each connector error that has occurred is registered in the re-execution time management table 126b. A connector name, an instance ID, an error end time, and a restart time are set in each record.

The connector name is the name of a connector where an error has occurred. The instance ID is an ID for identifying an error. The error end time is a time at which processing ended due to the occurrence of the error. The restart time is the time of a restart following an error.

Based on the execution log 121, the quality index evaluation unit 130 records a connector name, an instance ID, an error end time, and a restart time in the re-execution time management table 126b whenever an error occurs at a connector.

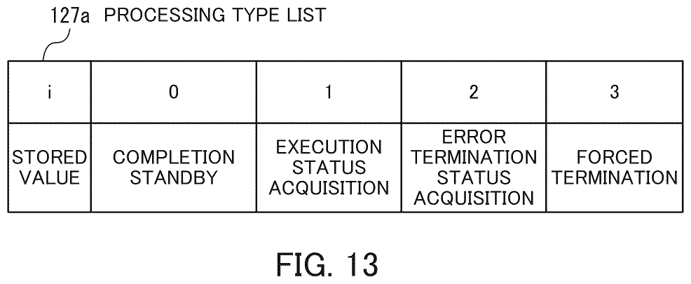

FIG. 13 depicts one example of a processing type list. In the processing type list 127a, the processing type is set as a stored value in association with the value of a variable i. In the processing type list 127a, a completion standby process is set in association with i=0. In the processing type list 127a, an execution status acquisition process is set in association with i=1. In the processing type list 127a, an error termination status acquisition process is set in association with i=2. In the processing type list 127a, a forced termination process is set in association with i=3.

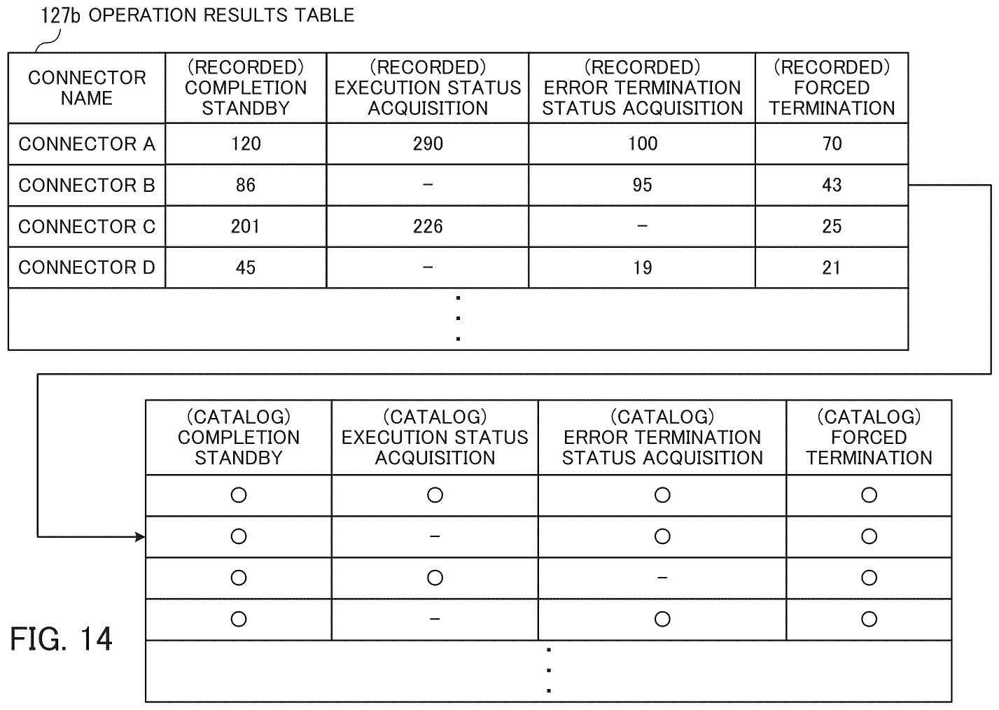

FIG. 14 depicts one example of an operation results table. A record for each connector is registered in the operation results table 127b. A connector name, (recorded) completion standby, (recorded) execution status acquisition, (recorded) error termination status acquisition, and (recorded) forced termination are set in each record. (Catalog) completion standby, (catalog) execution status acquisition, (catalog) error termination status acquisition, and (catalog) forced termination are also set in each record.

The connector name is the name of the connector. The (recorded) completion standby is the number of times a connector caused a cloud service being controlled to execute a completion standby process, which is counted based on the usage record. Based on the execution log 121, the quality index evaluation unit 130 counts the number of times the corresponding connector caused a cloud service being controlled to execute the completion standby process which ended normally, and stores the counted number of times in the (recorded) completion standby column.

The (recorded) execution status acquisition is the number of times a connector caused a cloud service being controlled to execute an execution status s acquisition process, which is counted based on the usage record. Based on the execution log 121, the quality index evaluation unit 130 counts the number of times the corresponding connector causes the cloud service being controlled to execute the execution status acquisition process which ended normally, and stores the counted number of times in the (recorded) execution status acquisition column.

The (recorded) error termination status acquisition is the number of times a connector causes the cloud service being controlled to execute an error termination status acquisition process, which is counted based on the usage record. Based on the execution log 121, the quality index evaluation unit 130 counts the number of times the corresponding connector causes the cloud service being controlled to execute the error termination status acquisition process which ended normally and stores the counted number of times in the (recorded) error termination status acquisition column.

The (recorded) forced termination is the number of times a connector caused a cloud service being controlled to execute a forced termination process, which is counted based on the usage record. Based on the execution log 121, the quality index evaluation unit 130 counts the number of times the corresponding connector caused a cloud service being controlled to execute the forced termination process which ended normally, and stores the counted number of times in (recorded) forced termination column. Note that “-” is set in the (recorded) completion standby, the (recorded) execution status acquisition, the (recorded) error termination status acquisition, and the (recorded) forced termination columns corresponding to a connector with no corresponding usage record.

(Catalog) completion standby is a catalog specification indicating whether a connector is capable of causing a cloud service being controlled to execute the completion standby process. (Catalog) execution status acquisition is a catalog specification indicating whether a connector is capable of causing a cloud service being controlled to execute the execution status acquisition process. (Catalog) error termination status acquisition is a catalog specification indicating whether a connector is capable of causing a cloud service being controlled to execute the error termination status acquisition process. (Catalog) forced termination is a catalog specification indicating whether a connector is capable of causing a cloud service being controlled to execute the forced termination process.

In the (catalog) completion standby, the (catalog) execution status acquisition, the (catalog) error termination status acquisition, and the (catalog) forced termination columns, “◯” indicates that a connector is capable of causing the controlled service to execute the corresponding process while “-” indicates that a connector is not capable of causing the controlled service to execute the corresponding process.

Quality requirements relating to flexibility of control of linked services by a connector include an ability to cause the controlled service to execute completion standby, execution status acquisition, error termination status acquisition, and/or forced termination processes. When the value of the (recorded) completion standby is 1 or more, the matching determination unit 150 determines that the corresponding connector satisfies a quality requirement of actual records indicating that the connector is capable of causing the controlled service to execute the completion standby process.

That is, when there is a record of the controlled service being caused to execute the completion standby process, the matching determination unit 150 determines that the corresponding connector satisfies a quality requirement of actual records indicating that the connector is capable of causing the controlled service to execute the completion standby process. When “◯” is set in the (catalog) completion standby column, the matching determination unit 150 determines that the corresponding connector satisfies a quality requirement of the catalog specification indicating that the connector is capable of causing the controlled service to execute the completion standby process.

When the value of the (recorded) execution status acquisition is 1 or more, the matching determination unit 150 determines that the corresponding connector satisfies a quality requirement of actual records indicating that the connector is capable of causing the controlled service to execute the execution status acquisition process. That is, when there is a record of the controlled service being caused to execute the execution status acquisition process, the matching determination unit 150 determines that the corresponding connector satisfies a quality requirement of actual records indicating that the connector is capable of causing the controlled service to execute the execution status acquisition process. When “◯” is set in the (catalog) execution status acquisition column, the matching determination unit 150 determines that the corresponding connector satisfies a quality requirement of the catalog specification indicating that the connector is capable of causing the controlled service to execute the execution status acquisition process.

When the value of the (recorded) error termination status acquisition is 1 or more, the matching determination unit 150 determines that the corresponding connector satisfies a quality requirement of actual records indicating that the connector is capable of causing the controlled service to execute the error termination status acquisition process. That is, when there is a record of the controlled service being caused to execute the error termination status acquisition process, the matching determination unit 150 determines that the corresponding connector satisfies a quality requirement of actual records indicating that the connector is capable of causing the controlled service to execute the error termination status acquisition process. When “◯” is set in the (catalog) error termination status acquisition column, the matching determination unit 150 determines that the corresponding connector satisfies a quality requirement of the catalog specification indicating that the connector is capable of causing the controlled service to execute the error termination status acquisition process.

When the value of the (recorded) forced termination is 1 or more, the matching determination unit 150 determines that the corresponding connector satisfies a quality requirement of actual records indicating that the connector is capable of causing the controlled service to execute a forced termination process. That is, when there is a record of the controlled service being caused to execute the forced termination process, the matching determination unit 150 determines that the corresponding connector satisfies a quality requirement of actual records indicating that the connector is capable of causing the controlled service to execute the forced termination process. When “◯” is set in the (catalog) forced termination column, the matching determination unit 150 determines that the corresponding connector satisfies a quality requirement of the catalog specification indicating that the connector is capable of causing the controlled service to execute the forced termination process.

In this way, it is possible to specify connectors that are capable of causing the controlled service to execute respective processes out of execution status acquisition, error termination status acquisition, and forced termination. By presenting the specified connectors to the user, it is possible to enable a user who requests flexible control of a linked service to select an appropriate connector.

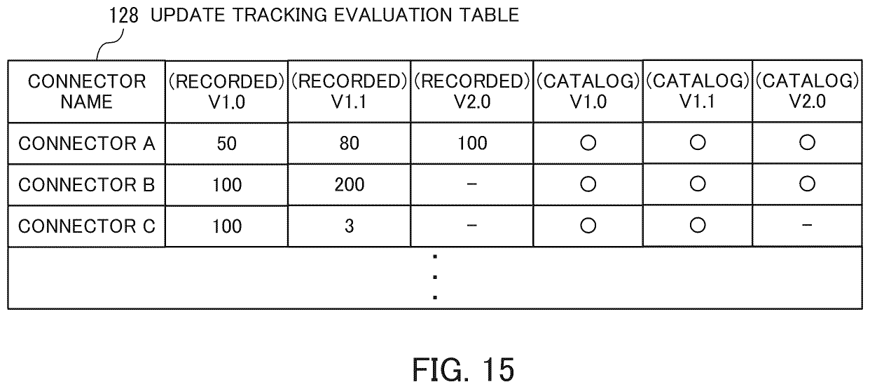

FIG. 15 depicts one example of an update tracking evaluation table. A record for each connector is registered in the update tracking evaluation table 128. A connector name, (recorded) v1.0, (recorded) v1.1, (recorded) v2.0, (catalog) v1.0, (catalog) v1.1, and (catalog) v2.0 are set in each record.

The connector name is the name of a connector. The (recorded) v1.0 value is the number of times the connector has controlled the API version 1.0 of the cloud service being controlled, which is counted based on the usage record. Based on the execution log 121, the quality index evaluation unit 130 counts the number of times the corresponding connector has caused the API version 1.0 of the cloud service being controlled to execute processing which ended normally, and stores the counted number in the (recorded) v1.0 column.

The (recorded) v1.1 value is the number of times the connector has controlled the API version 1.1 of the cloud service being controlled, which is counted based on the usage record. Based on the execution log 121, the quality index evaluation unit 130 counts the number of times the corresponding connector has caused the API version 1.1 of the cloud service being controlled to execute processing which ended normally, and stores the counted number in the (recorded) v1.1 column. The (recorded) v2.0 value is the number of times the connector has controlled the API version 2.0 of the cloud service being controlled, which is counted based on the usage record. Based on the execution log 121, the quality index evaluation unit 130 counts the number of times the corresponding connector has caused the API version 2.0 of the cloud service being controlled to execute processing which ended normally, and stores the counted number in the (recorded) v2.0 column. Note that “-” is set in the (recorded) v1.0, (recorded) v1.1, and (recorded) v2.0 columns corresponding to a connector with no corresponding usage record.

(Catalog) v1.0 is a catalog specification indicating whether the connector is capable of controlling the API version 1.0 of the cloud service being controlled. (Catalog) v1.1 is a catalog specification indicating whether the connector is capable of controlling the API version 1.1 of the cloud service being controlled. (Catalog) v2.0 is a catalog specification indicating whether the connector is capable of controlling the API version 2.0 of the cloud service being controlled. In the (catalog) v1.0, (catalog) v1.1, and (catalog) v2.0 columns, “◯” indicates that a connector is capable of controlling that API version while “-” indicates that a connector is not capable of controlling that API version.

Note that the API version 2.0 of each cloud service is the latest API version. The API version 1.0 and the API version 1.1 of each cloud service are API versions that are not End Of Life (EOL). EOL indicates an API version that is no longer supported.

Quality requirements for tracking updates of the controlled service include an ability to control the latest API version and an ability to control all non-latest API versions that are not EOL. When the value of (recorded) v2.0 is 1 or more (that is, when there is an actual result of a connector controlling the API version 2.0), the matching determination unit 150 determines that the corresponding connector satisfies a quality requirement of actual results indicating that the connector is capable of controlling the latest API version. When “◯” is set in the (catalog) v2.0 column, the matching determination unit 150 determines that the corresponding connector satisfies a quality requirement of the catalog specification indicating that the connector is capable of controlling the latest API version.

In addition, when values in both the (recorded) v1.0 and (recorded) v1.1 columns are 1 or more, the matching determination unit 150 determines that the corresponding connector satisfies a quality requirement of actual results indicating that the connector is capable of controlling all non-latest API versions that are not EOL. That is, when there are actual records of controlling the API versions 1.0 and 1.1, the matching determination unit 150 determines that the corresponding connector satisfies a quality requirement of actual results indicating that the connector is capable of controlling all non-latest API versions that are not EOL. When “◯” is set in the (catalog) v1.0 and (catalog) v1.1 columns, the matching determination unit 150 determines that the corresponding connector satisfies a quality requirement of the catalog specification indicating that the connector is capable of controlling all non-latest API versions that are not EOL.

In this way, it is possible to specify connectors capable of controlling the latest API version and connectors capable of controlling all non-latest API versions that are not EOL. By presenting the specified connectors to the user, it is possible to enable a user who requests tracking of updates of a cloud service being controlled to select an appropriate connector.

Next, multiple execution will be described.

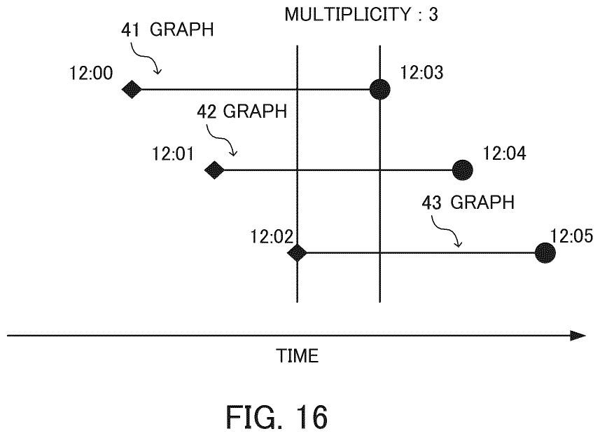

FIG. 16 depicts one example of multiple execution. Graphs 41, 42, and 43 indicate the time periods during which connectors caused a cloud service being controlled to execute processes. In the example of FIG. 16, the horizontal axis represents time.

The graph 41 indicates that the start time of a process is 12:00 and the end time of the process is 12:03. The graph 42 indicates that the start time of a process is 12:01 and the end time of the process is 12:04. The graph 43 indicates that the start time of a process is 12:02 and the end time of the process is 12:05.

The graphs 41, 42, and 43 indicate that the largest number of processes are executed in parallel between 12:02 and 12:03. The graphs 41, 42, and 43 indicate that three processes are executed in parallel between 12:02 and 12:03. Therefore, in the example of FIG. 16, processes are executed with a multiplicity of 3.

Next, a display screen for presenting connectors will be described. First, a screen for inputting conditions of the connectors to be presented will be described.

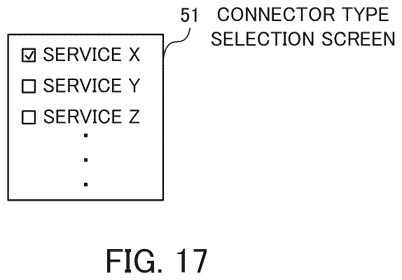

FIG. 17 depicts one example of a connector type selection screen. The input reception unit 140 displays the connector type selection screen 51 on a user terminal (for example, the user terminal 300b) of a user who is newly using the workflow control service 31. The connector type selection screen 51 is a screen for enabling a user to select a cloud service being controlled by a connector. The connector type selection screen 51 includes check boxes corresponding to cloud services. The input reception unit 140 receives the selection of a cloud service corresponding to a check box that has been checked.

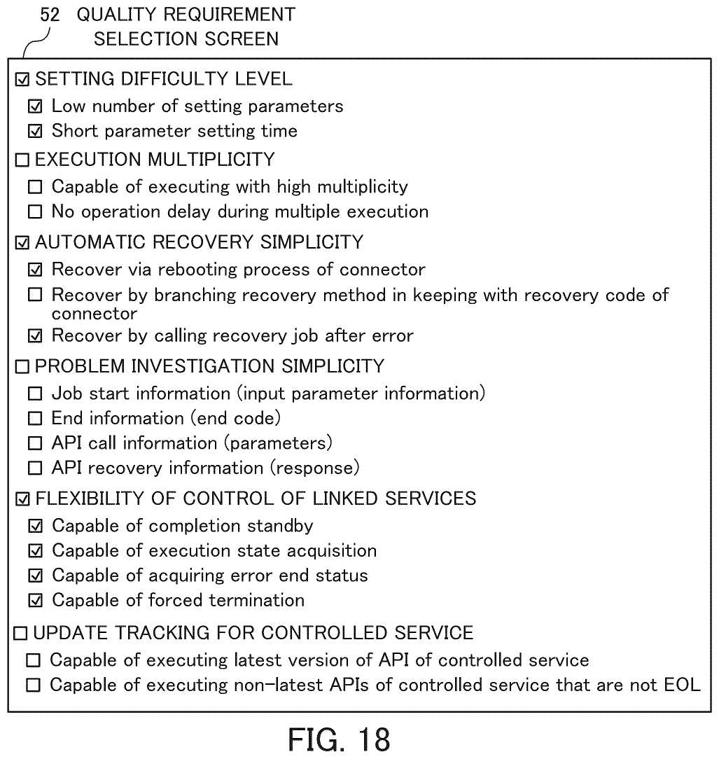

FIG. 18 depicts one example of a quality requirement selection screen. When the input reception unit 140 has received the selection of the cloud service on the connector type selection screen 51, the input reception unit 140 causes the user terminal 300b to display a quality requirement selection screen 52. The quality requirement selection screen 52 is a screen for enabling the user to select a quality requirement requested by the connector.

The quality requirement selection screen 52 includes check boxes corresponding to setting difficulty level, execution multiplicity, automatic recovery simplicity, problem investigation simplicity, flexibility of control of linked services, and update tracking for controlled service, which criteria for evaluating connectors. The quality requirement selection screen 52 also includes check boxes corresponding to the quality requirements relating to the above evaluation criteria.

The input reception unit 140 receives a selection of a quality requirement corresponding to a check box that has been checked. Note that when a check box corresponding to an evaluation criterion has been checked, check boxes corresponding to quality requirements related to that evaluation criterion become checked.

In this way, the input reception unit 140 receives the selection of a cloud service and quality requirements. The matching determination unit 150 determines connectors whose actual values or catalog specification match the selected quality requirements out of the connectors corresponding to the selected cloud service. Next, a presentation screen for the determination results of connectors that satisfy the quality requirements will be described.

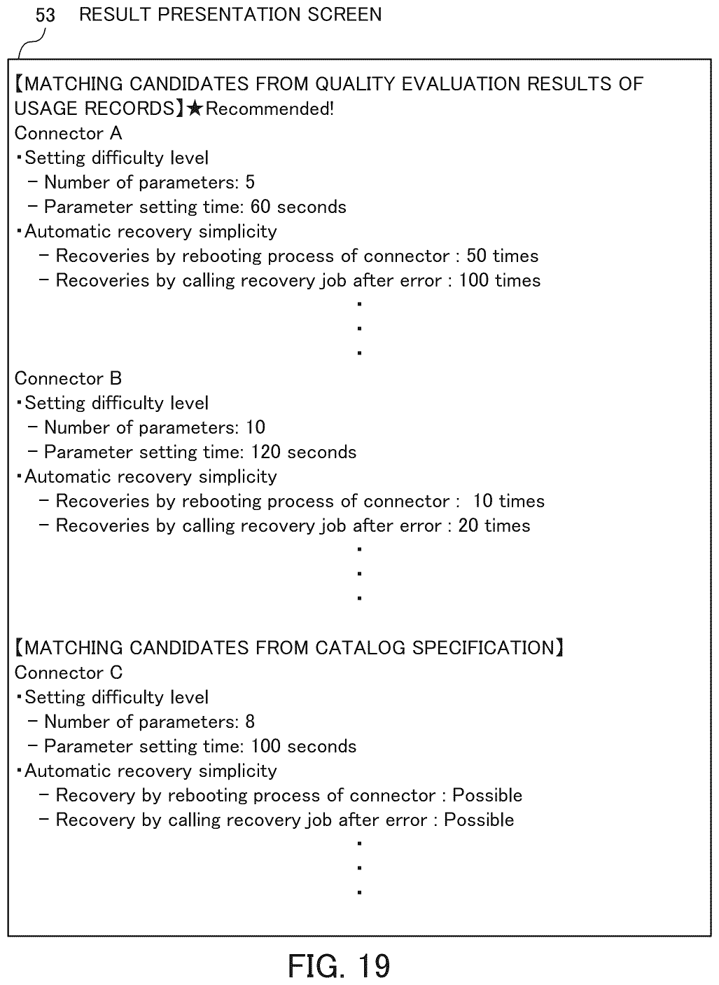

FIG. 19 depicts one example of a result presentation screen. When the matching determination unit 150 has specified a connector that satisfies the quality requirements, the matching connector display unit 160 displays a result presentation screen 53 on the user terminal 300b. The result presentation screen 53 is a screen for presenting connectors that satisfy the quality requirements to the user.

The result presentation screen 53 includes, in the upper part, information on connectors whose actual values match the quality requirements selected by the user. The connector information in the upper part of the result presentation screen 53 includes connector names and actual values for each quality requirement. In the lower part the result presentation screen 53 also includes information on connectors whose catalog specification satisfy the quality requirements selected by the user. The connector information in the lower part of the result presentation screen 53 includes connector names and catalog specifications of each quality requirement. As the connector information, the actual values and the catalog specifications of the quality requirements selected by the user may be displayed, and the display may be expanded to include actual values and catalog specifications of quality requirements not selected by the user.

By displaying the result presentation screen 53 in this way, it is possible to present connectors whose actual values match the quality requirements selected by the user and connectors whose catalog specifications match the quality requirements. This enables the user to appropriately select a connector with desired functions. In addition, in the result presentation screen 53, information on connectors whose actual values satisfy the quality requirements is placed in the upper part and information on connectors whose catalog specifications satisfy the quality requirements is placed in the lower part. By doing so, it is possible to indicate to the user that connectors whose usage records satisfy the quality requirements selected by the user are more highly recommended than connectors whose catalog specifications satisfy the quality requirements.

Next, the procedure of the quality evaluation process for connectors will be described in detail.

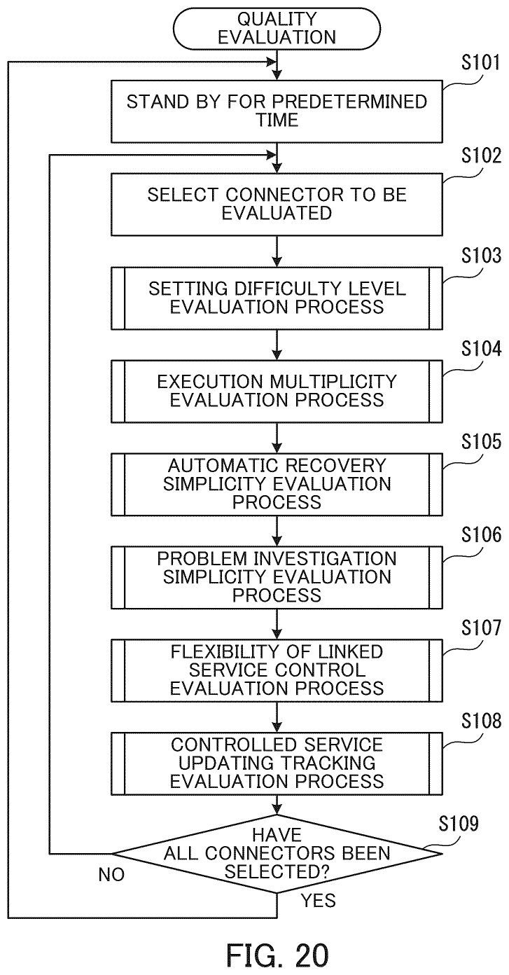

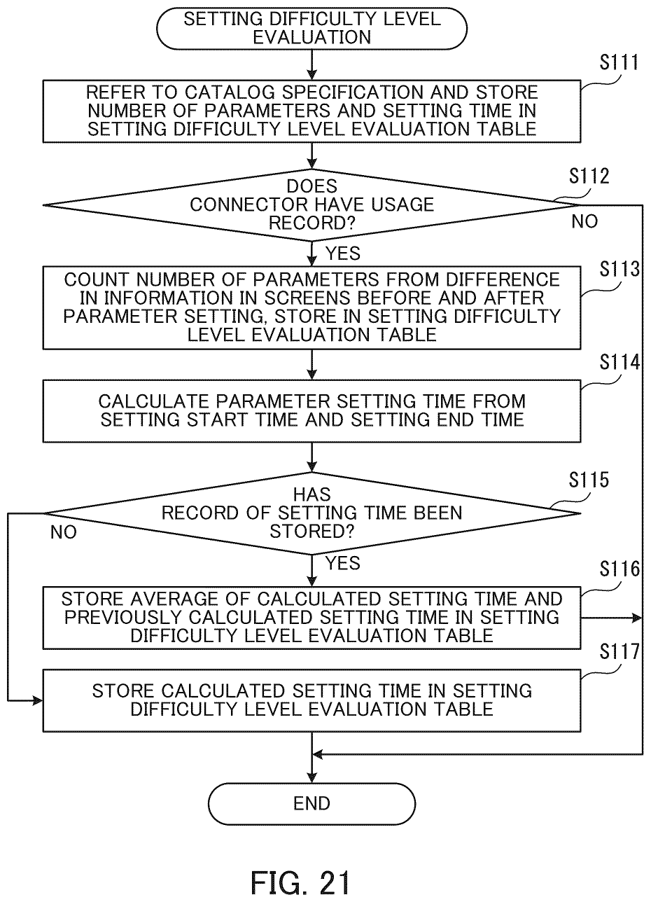

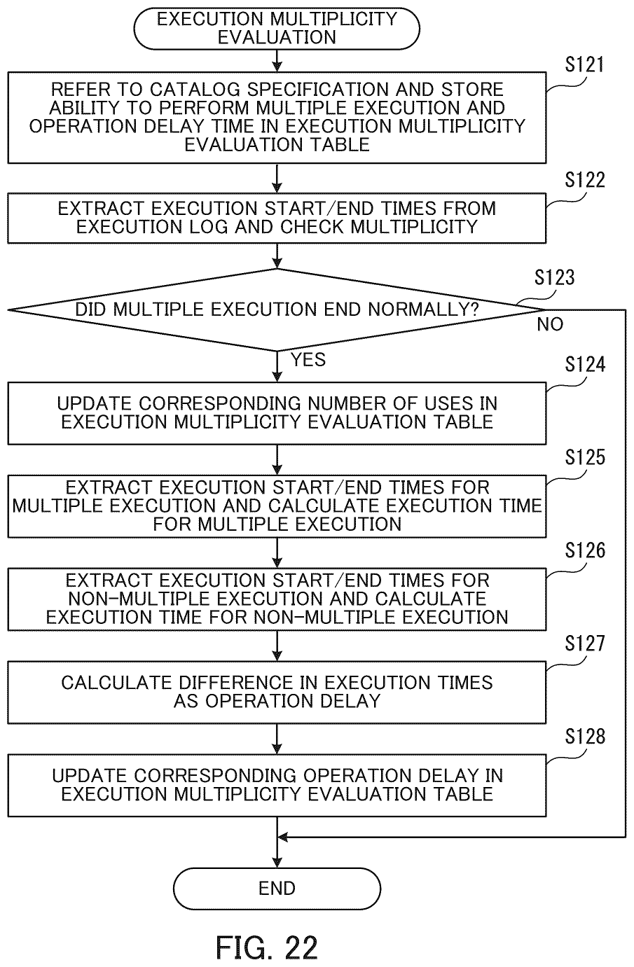

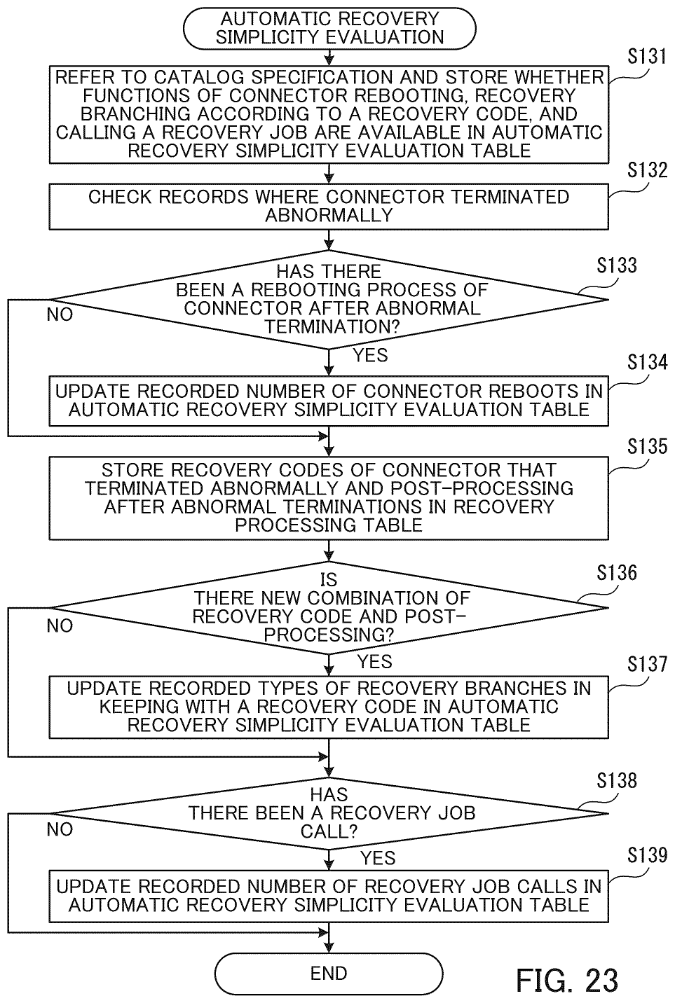

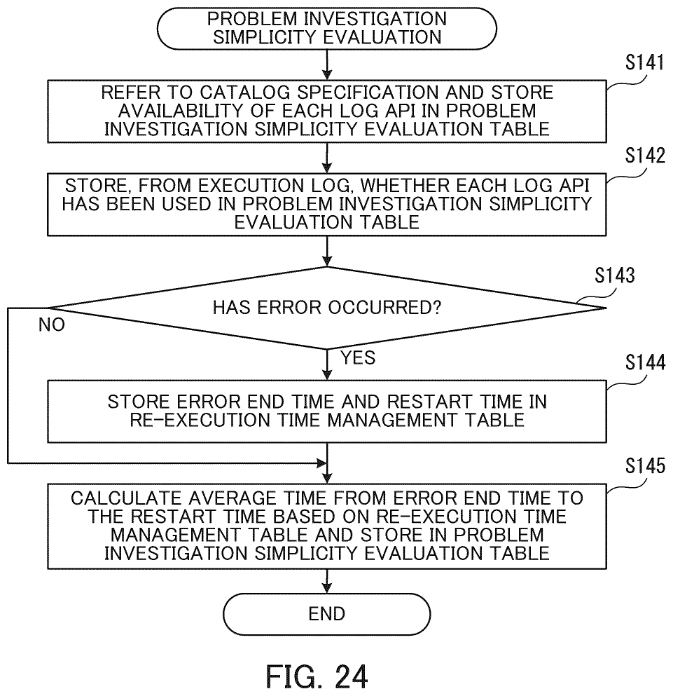

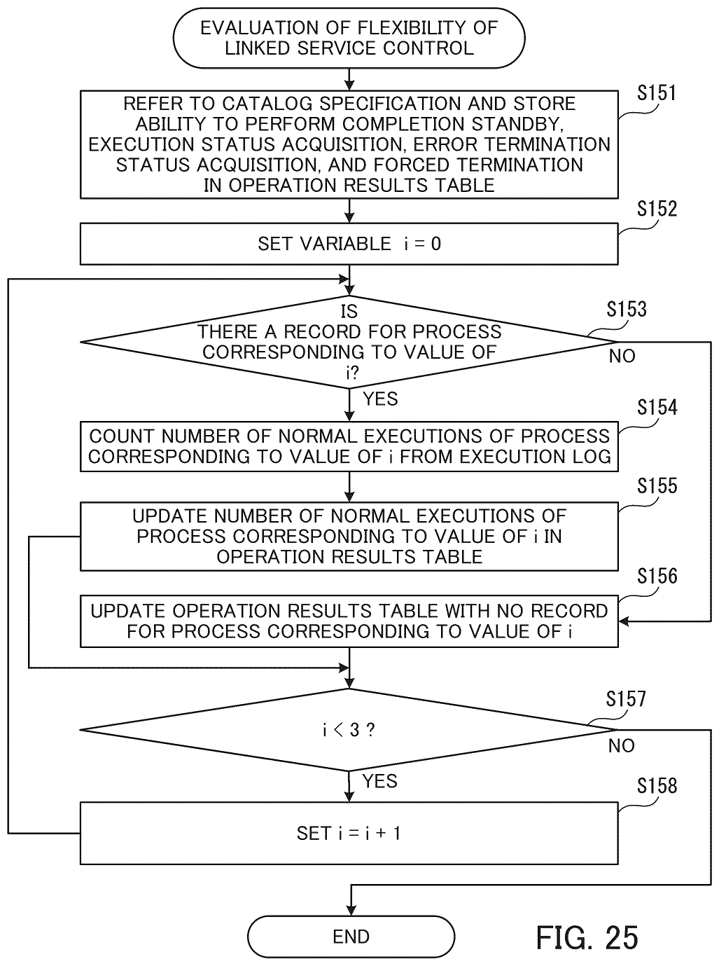

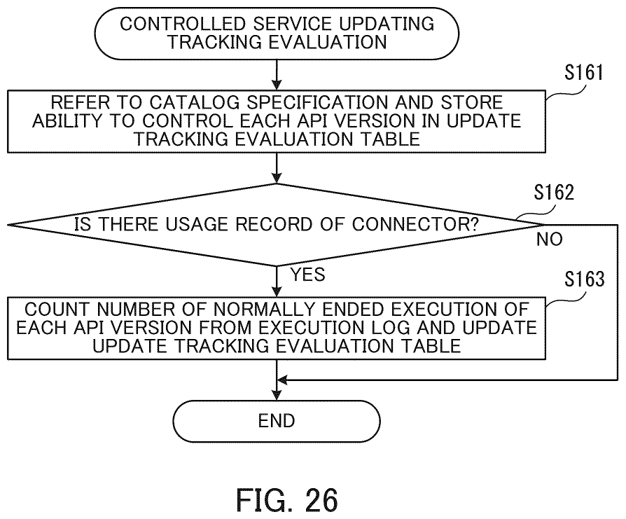

FIG. 20 is a flowchart depicting an example procedure of the quality evaluation process. The processing depicted in FIG. 20 is described below in order of the step numbers.

[Step S101] The quality index evaluation unit 130 stands by for a predetermined time (for example, one hour).

[Step S102] The quality index evaluation unit 130 selects a connector to be evaluated out of the connectors 110a, 110b,

[Step S103] The quality index evaluation unit 130 executes a setting difficulty level evaluation process on the connector to be evaluated that was selected in step S102. The setting difficulty level evaluation process will be described in detail later (see FIG. 21).

[Step S104] The quality index evaluation unit 130 executes an execution multiplicity evaluation process on the connector to be evaluated that was selected in step S102. The execution multiplicity evaluation process will be described in detail later (see FIG. 22).

[Step S105] The quality index evaluation unit 130 executes an automatic recovery simplicity evaluation process on the connector to be evaluated that was selected in step S102. The automatic recovery simplicity evaluation process will be described in detail later (see FIG. 23).

[Step S106] The quality index evaluation unit 130 executes a problem investigation simplicity evaluation process on the connector to be evaluated that was selected in step S102. The problem investigation simplicity evaluation process will be described in detail later (see FIG. 24).

[Step S107] The quality index evaluation unit 130 executes a flexibility of linked service control evaluation process on the connector to be evaluated that was selected in step S102. The flexibility of linked service control evaluation process will be described in detail later (see FIG. 25).

[Step S108] The quality index evaluation unit 130 executes a controlled service updating tracking evaluation process on the connector to be evaluated that was selected in step S102. The controlled service updating tracking evaluation process will be described in detail later (see FIG. 26).

[Step S109] The quality index evaluation unit 130 determines whether all of the connectors 110a, 110b, have been selected for evaluation. When the quality index evaluation unit 130 determines that all of the connectors 110a, 110b, . . . have been selected, the processing proceeds to step S101. When the quality index evaluation unit 130 determines that not all of the connectors 110a, 110b, . . . have been selected, the processing proceeds to step S102.

In this way, the quality of the connectors 110a, 110b, . . . is evaluated at intervals of a predetermined time.

FIG. 21 is a flowchart depicting an example procedure of the setting difficulty level evaluation process. The processing depicted in FIG. 21 is described below in order of the step numbers.

[Step S111] The quality index evaluation unit 130 refers to the catalog specification of the connector to be evaluated, and stores the ability to perform multiple execution and the operation delay time during multiple execution in the setting difficulty level evaluation table 123. As one example, the quality index evaluation unit 130 stores a catalog specification of the number of parameters of the connector to be evaluated in the (catalog) number of parameters of the record of the connector to be evaluated in the setting difficulty level evaluation table 123. In addition, the quality index evaluation unit 130 stores the catalog specification of the setting time of the parameters of the connector to be evaluated in the (catalog) setting time (in seconds) of the same record.

[Step S112] The quality index evaluation unit 130 refers to the execution log 121 and determines whether there has been a usage record of the connector to be evaluated following the previous setting difficulty level evaluation process. When it is determined that there has been a usage record of the connector to be evaluated, the quality index evaluation unit 130 advances the processing to step S113. When it has been determined that there has been no usage record of the connector to be evaluated, the quality index evaluation unit 130 ends the processing.

[Step S113] The quality index evaluation unit 130 refers to the execution log 121 and counts the number of parameters from the differences in the screen information before and after the setting of parameters for the connector to be evaluated. The quality index evaluation unit 130 then stores the counted number of parameters in the (recorded) number of parameters of the record of the connector to be evaluated in the setting difficulty level evaluation table 123.

[Step S114] The quality index evaluation unit 130 refers to the execution log 121 and specifies the parameter setting start time and the parameter setting end time of the connector to be evaluated. The quality index evaluation unit 130 then calculates the difference between the setting start time and the setting end time of the parameters as the parameter setting time.

[Step S115] The quality index evaluation unit 130 determines whether a record of the parameter setting time has been stored. For example, when a value is stored in the (recorded) setting time (in seconds) of the record of the connector to be evaluated in the setting difficulty level evaluation table 123, the quality index evaluation unit 130 determines that an actual result of the parameter setting time has been stored. When the quality index evaluation unit 130 has determined that a record of the parameter setting time has been stored, the processing proceeds to step S116. When the quality index evaluation unit 130 has determined that an actual record of the parameter setting time has not been stored, the processing proceeds to step S117.

[Step S116] The quality index evaluation unit 130 calculates an average of the parameter setting time calculated in the current setting difficulty level evaluation process and the parameter setting time calculated in the previous setting difficulty level evaluation process. The quality index evaluation unit 130 stores the calculated average of the parameter setting times in the (recorded) setting time (in seconds) of the record of the connector to be evaluated in the setting difficulty level evaluation table 123. The processing then ends.

[Step S117] The quality index evaluation unit 130 stores the parameter setting time calculated in the current setting difficulty level evaluation process in the (recorded) setting time (in seconds) of the record of the connector to be evaluated in the setting difficulty level evaluation table 123.

In this way, the number of parameters and the parameter setting time of the connector to be evaluated are calculated from the execution log 121. By doing so, it is possible to appropriately evaluate the parameter setting difficulty level based on the usage record of a connector.

FIG. 22 is a flowchart depicting an example procedure of an execution multiplicity evaluation process. The processing depicted in FIG. 22 is described below in order of the step numbers.

[Step S121] The quality index evaluation unit 130 refers to the catalog specification of the connector to be evaluated, and stores the ability to perform multiple execution and the operation delay time during multiple execution in the execution multiplicity evaluation table 124. For example, the quality index evaluation unit 130 stores a catalog specification indicating whether the connector to be evaluated is capable of multiple execution of 1 to 100 processes in the (catalog) 1 to 100 multiple executions column of the record of the connector to be evaluated in the execution multiplicity evaluation table 124. In addition, the quality index evaluation unit 130 stores a catalog specification of the operation delay time when the connector to be evaluated performs 1 to 100 processes through multiplexing in the (catalog) operation delay for 1 to 100 multiple executions (in seconds) of the record of the connector to be evaluated in the execution multiplicity evaluation table 124.

In addition, the quality index evaluation unit 130 stores a catalog specification indicating whether the connector to be evaluated is capable of multiple execution of 101 or more processes in the (catalog) 101 or more multiple executions column of the record of the connector to be evaluated in the execution multiplicity evaluation table 124. In addition, the quality index evaluation unit 130 stores a catalog specification of the operation delay time when the connector to be evaluated performs 101 or more processes through multiplexing in the (catalog) operation delay for 101 or more multiple executions (in seconds) of the record of the connector to be evaluated in the execution multiplicity evaluation table 124.

[Step S122] The quality index evaluation unit 130 extracts, from the execution log 121, the execution start time and the execution end time of processes executed by the connector to be evaluated following the previous execution multiplicity evaluation process. The quality index evaluation unit 130 then checks the multiplicity of the processes performed by the connector to be evaluated. For example, the quality index evaluation unit 130 specifies, as the multiplicity, the number of processes in a period during which the largest number of processes were executed in parallel from the execution start time and the execution end time of the respective extracted processes.

[Step S123] The quality index evaluation unit 130 determines whether the multiple execution ended normally. When the quality index evaluation unit 130 has determined that the multiple execution ended normally, the processing proceeds to step S124. When the quality index evaluation unit 130 has determined that the multiple execution did not end normally, the quality index evaluation unit 130 ends the processing.

[Step S124] The quality index evaluation unit 130 updates the corresponding number of uses in the execution multiplicity evaluation table 124. As one example, when the multiplicity checked in step S122 was 1 to 100, the quality index evaluation unit 130 adds 1 to the value in the (recorded) 1 to 100 multiple executions column of the record of the connector to be evaluated in the execution multiplicity evaluation table 124. When the multiplicity checked in step S122 was 101 or more, the quality index evaluation unit 130 adds 1 to the value in the (recorded) 101 or more multiple executions column of the record.

[Step S125] The quality index evaluation unit 130 extracts the execution start time and the execution end time for when multiple execution was performed. The quality index evaluation unit 130 then calculates the execution time for which the multiple execution was performed. For example, the quality index evaluation unit 130 calculates a difference between an execution start time and an execution end time as an execution time for the respective processes executed by multiplexing, and calculates an average of the execution times of the processes as the execution time when the processes are executed by multiplexing.

[Step S126] The quality index evaluation unit 130 extracts the execution start time and the execution end time when multiple execution is not performed. The quality index evaluation unit 130 calculates a difference between the extracted execution start time and end time as the execution time when multiple execution is not performed.

[Step S127] The quality index evaluation unit 130 calculates, as the operation delay, the difference between the execution time during multiple execution that was calculated in step S125 and the execution time when multiple execution is not performed that was calculated in step S126.

[Step S128] The quality index evaluation unit 130 updates the corresponding operation delay in the execution multiplicity evaluation table 124. As one example, when the multiplicity is 1 to 100, the quality index evaluation unit 130 compares the value in the (recorded) operation delay for 1 to 100 multiple executions (in seconds) of the record of the connector to be evaluated in the execution multiplicity evaluation table 124 with the operation delay calculated in step S127. When the calculated operation delay is larger than the value in the (recorded) operation delay for 1 to 100 multiple executions (in seconds) column, the quality index evaluation unit 130 updates the value in the (recorded) operation delay for 1 to 100 multiple executions (in seconds) column to the calculated operation delay.

When the multiplicity is 101 or more, the quality index evaluation unit 130 compares the value in the (recorded) operation delay for 101 or more multiple executions (in seconds) column of the record of the connector to be evaluated in the execution multiplicity evaluation table 124 with the operation delay calculated in step S127. When the calculated operation delay is larger than the value in the (recorded) operation delay for 101 or more multiple executions (in seconds) column, the quality index evaluation unit 130 updates the value in the (recorded) operation delay for 101 or more multiple executions (in seconds) column to the calculated operation delay.

In this way, the actual number of times multiple executions are performed by the connector to be evaluated and the maximum value of the operation delay when multiple executions are performed are calculated from the execution log 121. By doing so, it is possible to appropriately evaluate performance during multiplex execution based on the usage record of the connector.

FIG. 23 is a flowchart depicting an example procedure of an automatic recovery simplicity evaluation process. The processing depicted in FIG. 23 is described below in order of the step numbers.

[Step S131] The quality index evaluation unit 130 refers to the catalog specification of the connector to be evaluated, and stores, in the automatic recovery simplicity evaluation table 125b, whether the connector is equipped with the functions of connector rebooting, recovery branching according to a recovery code, and calling a recovery job. As one example, the quality index evaluation unit 130 stores a catalog specification indicating whether the connector to be evaluated has a rebooting function in the (catalog) connector reboots column of the record of the connector to be evaluated in the: recovery simplicity evaluation table 125b.

In addition, the quality index evaluation unit 130 stores a catalog specification indicating whether the connector to be evaluated is equipped with a function for branching the recovery according to a recovery code in the (catalog) (catalog) recovery branches according to recovery code column of the record. In addition, the quality index evaluation unit 130 stores a catalog specification indicating whether the connector to be evaluated is equipped with a function for calling a recovery job in the (catalog) recovery job calls column of the record.

[Step S132] The quality index evaluation unit 130 refers to the execution log 121 to check records from when the connector to be evaluated terminated abnormally following the previous automatic recovery simplicity evaluation process.

[Step S133] The quality index evaluation unit 130 determines whether there has been a rebooting process of the connector that terminated abnormally. As one example, when the execution log 121 includes a record of a rebooting process corresponding to the recording of an abnormal termination confirmed in step S132, the quality index evaluation unit 130 determines that there has been a rebooting process of the connector that terminated abnormally. When the quality index evaluation unit 130 has determined that there has been a rebooting process of the connector that terminated abnormally, the processing proceeds to step S134. When the quality index evaluation unit 130 determines that there was no rebooting process of the connector that terminated abnormally, the processing proceeds to step S135.

[Step S134] The quality index evaluation unit 130 updates the recorded number of reboots of the connector in the automatic recovery simplicity evaluation table 125b. As one example, the quality index evaluation unit 130 counts the number of records from abnormal terminations for which a corresponding rebooting process was confirmed in step S132. The quality index evaluation unit 130 then adds the counted number to the (recorded) connector reboots value in the record of the connector being evaluated in the automatic recovery simplicity evaluation table 125b.

[Step S135] Based on the records checked in step S132, the quality index evaluation unit 130 stores the recovery codes of the connector that terminated abnormally and the post-processing after the abnormal terminations in the recovery processing table 125a. As one example, the quality index evaluation unit 130 adds, to the recovery processing table 125a, a record of a combination of the name of the connector to be evaluated, a recovery code indicating a situation at the time of recovery from the abnormal termination, and post-processing after the abnormal termination.

[Step S136] The quality index evaluation unit 130 determines whether the combination of the recovery code and the post-processing is new. For example, when the combination of the connector name, the recovery code, and the post-processing added to the recovery processing table 125a in step S135 is not already registered, the quality index evaluation unit 130 determines that the combination of the recovery code and the post-processing is new. When the quality index evaluation unit 130 has determined that the combination of the recovery code and the post-processing is new, the processing proceeds to step S137. When the quality index evaluation unit 130 has determined that the combination of the recovery code and the post-processing is not new, the processing proceeds to step S138.

[Step S137] The quality index evaluation unit 130 updates the recorded types of recovery branches in the automatic recovery simplicity evaluation table 125b. As one example, the quality index evaluation unit 130 counts the number of new combinations of a recovery code and post-processing added to the recovery processing table 125a in step S135. The quality index evaluation unit 130 adds this counted number to the (recorded) recovery branches according to recovery code column of the record of the connector to be evaluated in the automatic recovery simplicity evaluation table 125b.

[Step S138] The quality index evaluation unit 130 determines whether a recovery job call process has been executed in the post-processing following an abnormal termination. For example, the quality index evaluation unit 130 determines that the recovery job calling process has been executed when a record indicating that the post-processing is the recovery job call process has been stored in the recovery processing table 125a in step S135. When the quality index evaluation unit 130 determines that the recovery job calling process has been executed, the processing proceeds to step S139. When the quality index evaluation unit 130 determines that the recovery job call process has not been executed, the quality index evaluation unit 130 ends the processing.

[Step S139] The quality index evaluation unit 130 updates the recorded number of recovery job calls in the automatic recovery simplicity evaluation table 125b. As one example, the quality index evaluation unit 130 counts the number of records in which the post-processing registered in the recovery processing table 125a in step S135 is a recovery job call. The quality index evaluation unit 130 then adds the counted number to the (recorded) recovery job calls column of the record of the connector to be evaluated in the automatic recovery simplicity evaluation table 125b.

In this way, the number of executions of the connector rebooting process, a recovery branching process according to a recovery code, and the recovery job call process by the connector to be evaluated are counted from the execution log 121. This makes it possible to appropriately evaluate the ease of automatic recovery based on the usage record of a connector.

FIG. 24 is a flowchart depicting an example procedure of a problem investigation simplicity evaluation process. The processing depicted in FIG. 24 is described below in order of the step numbers.

[Step S141] The quality index evaluation unit 130 refers to the catalog specification of the connector to be evaluated, and stores availability of each log API out of the job start API, the job end information log API, the call information log API, and the recovery information log API in the problem investigation simplicity evaluation table 126a. As one example, the quality index evaluation unit 130 stores a catalog specification indicating whether the connector to be evaluated is capable of using the job start API in the (catalog) job start API column of the record of the connector to be evaluated in the problem investigation simplicity evaluation table 126a. In addition, the quality index evaluation unit 130 stores a catalog specification indicating whether the connector to be evaluated is capable of using the job end information log API in the (catalog) job end information log API column of that record.

In addition, the quality index evaluation unit 130 stores a catalog specification indicating whether the connector to be evaluated is capable of using the call information log API in the (catalog) call information log API column of that record. The quality index evaluation unit 130 also stores a catalog specification indicating whether the connector to be evaluated is capable of using the recovery information log API in the (catalog) recovery information log API column of that record.

[Step S142] The quality index evaluation unit 130 stores, from the execution log 121, whether each log API out of the job start API, the job end information log API, the call information log API, and the recovery information log API has been used by the connector to be evaluated in the problem investigation simplicity evaluation table 126a. As one example, the quality index evaluation unit 130 checks, from the execution log 121, the presence or absence of a record in which the connector to be evaluated has used the job start API, the job end information log API, the call information log API, and the recovery information log API.

The quality index evaluation unit 130 stores the presence or absence of a record in which the connector to be evaluated has used the job start API in the (recorded) job start API column of the record of the connector to be evaluated in the problem investigation simplicity evaluation table 126a. In addition, the quality index evaluation unit 130 stores the presence or absence of a record in which the connector to be evaluated has used the job end information log API in the (recorded) job end information log API column of that record. The quality index evaluation unit 130 also stores the presence or absence of a record in which the connector to be evaluated has used the call information log API in the (recorded) call information log API column of that record. In addition, the quality index evaluation unit 130 stores the presence or absence of a record in which the connector to be evaluated has used the recovery information log API in the (recorded) recovery information log API column of that record.

[Step S143] The quality index evaluation unit 130 refers to the execution log 121 and determines whether an error has occurred at the connector to be evaluated following the previous problem investigation simplicity evaluation process. When the quality index evaluation unit 130 has determined that an error has occurred at the connector to be evaluated, the processing proceeds to step S144. When the quality index evaluation unit 130 has determined that no error has occurred at the connector to be evaluated, the processing proceeds to step S145.

[Step S144] The quality index evaluation unit 130 stores the error end time and the restart time in the re-execution time management table 126b. As one example, the quality index evaluation unit 130 specifies the error end time and the restart time of the error that occurred at the connector to be evaluated following the previous problem investigation simplicity evaluation process and has been recorded in the execution log 121. The quality index evaluation unit 130 then stores the specified error end time and restart time in the re-execution time management table 126b in association with the name of the connector to be evaluated and an unused instance ID.

[Step S145] The quality index evaluation unit 130 calculates an average time from the error end time to the restart time based on the re-execution time management table 126b. As one example, the quality index evaluation unit 130 calculates a time from the error end time to the restart time for each record in which the name of the connector to be evaluated is registered, and calculates an average time for these calculated times. The quality index evaluation unit 130 stores the calculated average time in the average time from an error to re-execution (H) column of the record of the connector to be evaluated in the problem investigation simplicity evaluation table 126a.

In this way, from the execution log 121, it is specified whether each log API out of the job start API, the job end information log API, the call information log API, and the recovery information log API is usable by the connector to be evaluated. Accordingly, it is possible to appropriately evaluate problem investigation simplicity based on the usage record of the connector.

FIG. 25 is a flowchart depicting an example procedure of a process of evaluating flexibility of linked service control. The processing depicted in FIG. 25 is described below in order of the step numbers.

[Step S151] The quality index evaluation unit 130 refers to the catalog specification of the connector to be evaluated, and stores, in the operation results table 127b, whether it is possible to cause the controlled service to execute each of the completion standby process, the execution status acquisition process, the error termination status acquisition process, and the forced termination process. As one example, the quality index evaluation unit 130 stores a catalog specification indicating whether the connector to be evaluated is capable of causing the cloud service being controlled to execute the completion standby process in the (catalog) completion standby column of the record of the connector to be evaluated in the operation results table 127b. In addition, the quality index evaluation unit 130 stores a catalog specification indicating whether the connector to be evaluated is capable of causing the cloud service being controlled to execute the execution status acquisition process in the (catalog) execution status acquisition column of that record.

The quality index evaluation unit 130 also stores a catalog specification indicating whether the connector to be evaluated is capable of causing the cloud service being controlled to execute the error termination status acquisition process in the (catalog) error termination status acquisition column of that record. In addition, the quality index evaluation unit 130 stores a catalog specification indicating whether the connector to be evaluated is capable of causing the cloud service being controlled to execute the forced termination process in the (catalog) forced termination of that record.

[Step S152] The quality index evaluation unit 130 sets the variable i=0.

[Step S153] The quality index evaluation unit 130 refers to the execution log 121 and determines whether there is a record in which the connector to be evaluated has executed the process corresponding to the value of the variable i in the processing type list 127a. When it has been determined that there is a record in which the process corresponding to the value of the variable i is executed by the connector to be evaluated, the quality index evaluation unit 130 advances the processing to step S154. When it has been determined that there is no record in which the process corresponding to the value of the variable i is executed by the connector to be evaluated, the quality index evaluation unit 130 advances the processing to step S156.

[Step S154] The quality index evaluation unit 130 refers to the execution log 121 and counts the number of times the connector to be evaluated has caused the cloud service being controlled to execute the process corresponding to the value of the variable i which ended normally.

[Step S155] The quality index evaluation unit 130 updates the number of normal executions of the process corresponding to the value of the variable i in the operation results table 127b. As one example, when the variable i=0, the quality index evaluation unit 130 stores the number of normally ended executions counted in step S154 in the (recorded) completion standby column of the record of the connector to be evaluated in the operation results table 127b. When the variable i=1, the quality index evaluation unit 130 stores the number of normally ended executions counted in step S154 in the (recorded) execution status acquisition column of that record. When the variable i=2, the quality index evaluation unit 130 stores the number of normally ended executions counted in step S154 in the (recorded) error termination status acquisition column of that record. When the variable i=3, the quality index evaluation unit 130 stores the number of normally ended executions counted in step S154 in the (recorded) forced termination column of that record. The processing then proceeds to step S157.

[Step S156] The quality index evaluation unit 130 updates the operation results table 127b with no record for process corresponding to the value of the variable i. As one example, when the variable i=0, the quality index evaluation unit 130 stores information (for example, “-”) indicating that there is no usage record in the (recorded) completion standby column of the record of the connector to be evaluated in the operation results table 127b. When the variable i=1, the quality index evaluation unit 130 stores information indicating that there is no usage record in the (recorded) execution status acquisition column of that record. When the variable i=2, the quality index evaluation unit 130 stores information indicating that there is no usage record in the (recorded) error termination status acquisition column of that record. When the variable i=3, the quality index evaluation unit 130 stores information indicating that there is no usage record in the (recorded) forced termination column of that record.

[Step S157] The quality index evaluation unit 130 determines whether the variable i is less than 3 (i<3). When the quality index evaluation unit 130 has determined that the variable i is less than 3, the processing proceeds to step S158. When it has been determined that the variable i is equal to or greater than 3, the quality index evaluation unit 130 ends the processing.

[Step S158] The quality index evaluation unit 130 sets the variable i to i+1. The processing then proceeds to step S153.

In this way, the number of times the connector to be evaluated causes the controlled service to execute the completion standby process, the execution status acquisition process, the error termination status acquisition process, and the forced termination process which end normally are counted from the execution log 121. Accordingly, it is possible to appropriately evaluate, based on the usage record of the connector, whether it is possible to flexibly control the linked service.

FIG. 26 is a flowchart depicting an example procedure of a controlled service updating tracking evaluation process. The processing depicted in FIG. 26 is described below in order of the step numbers.

[Step S161] The quality index evaluation unit 130 refers to the catalog specification of the connector to be evaluated and stores the ability to control each API version of the cloud service being controlled in the update tracking evaluation table 128. As one example, the quality index evaluation unit 130 stores the catalog specification indicating whether the connector to be evaluated is capable of controlling the API version 1.0 of the cloud service being controlled in the (catalog) v1.0 column of the record of the connector to be evaluated in the update tracking evaluation table 128.

The quality index evaluation unit 130 also stores the catalog specification indicating whether the connector to be evaluated is capable of controlling the API version 1.1 of the cloud service being controlled in the (catalog) v1.1 column of that record. In addition, the quality index evaluation unit 130 stores the catalog specification indicating whether the connector to be evaluated is capable of controlling the API version 2.0 of the cloud service being controlled in the (catalog) v2.0 column of that record.

[Step S162] The quality index evaluation unit 130 refers to the execution log 121 and determines whether there is a usage record of the connector to be evaluated. When it has been determined that there is a usage record of the connector to be evaluated, the quality index evaluation unit 130 advances the processing to step S163. When it has been determined that there is no usage record of the connector to be evaluated, the quality index evaluation unit 130 ends the processing.

[Step S163] The quality index evaluation unit 130 counts, based on the execution log 121, the number of normally ended executions for each API version by the connector to be evaluated, and updates the update tracking evaluation table 128. As one example, the quality index evaluation unit 130 counts the number of records in the execution log 121 in which the connector to be evaluated caused the API version 1.0 of the cloud service being controlled to execute processing which ended normally. The quality index evaluation unit 130 then stores the counted number of records in the (recorded) v1.0 column of the record of the connector to be evaluated in the update tracking evaluation table 128.

In addition, the quality index evaluation unit 130 counts the number of records in the execution log 121 in which the connector to be evaluated caused the API version 1.1 of the cloud service being controlled to execute processing which ended normally. The quality index evaluation unit 130 then stores the counted number of records in the (recorded) v1.1 column of the record of the connector to be evaluated in the update tracking evaluation table 128. The quality index evaluation unit 130 also counts the number of records in the execution log 121 in which the connector to be evaluated caused the API version 2.0 of the cloud service being controlled to execute processing which ended normally. The quality index evaluation unit 130 then stores the counted number of records in the (recorded) v2.0 column of the record of the connector to be evaluated in the update tracking evaluation table 128.

In this way, the number of times processing of each API version of the cloud service being controlled by the connector to be evaluated has ended normally is counted from the execution log 121. By doing so, it is possible to appropriately evaluate whether updates are being tracked based on the usage record of a connector.

Note that the connectors 110a, 110b, . . . may include connectors provided by a third party aside from the business operator that provides the workflow control service 31 and/or the business operator that provides the cloud service being controlled. According to the evaluation processes in FIGS. 21 to 26, it is possible to evaluate the quality of a connector provided by a third party from viewpoints of operability and maintainability.

Next, the procedure of a connector presentation process that presents connectors to a user will be described in detail.

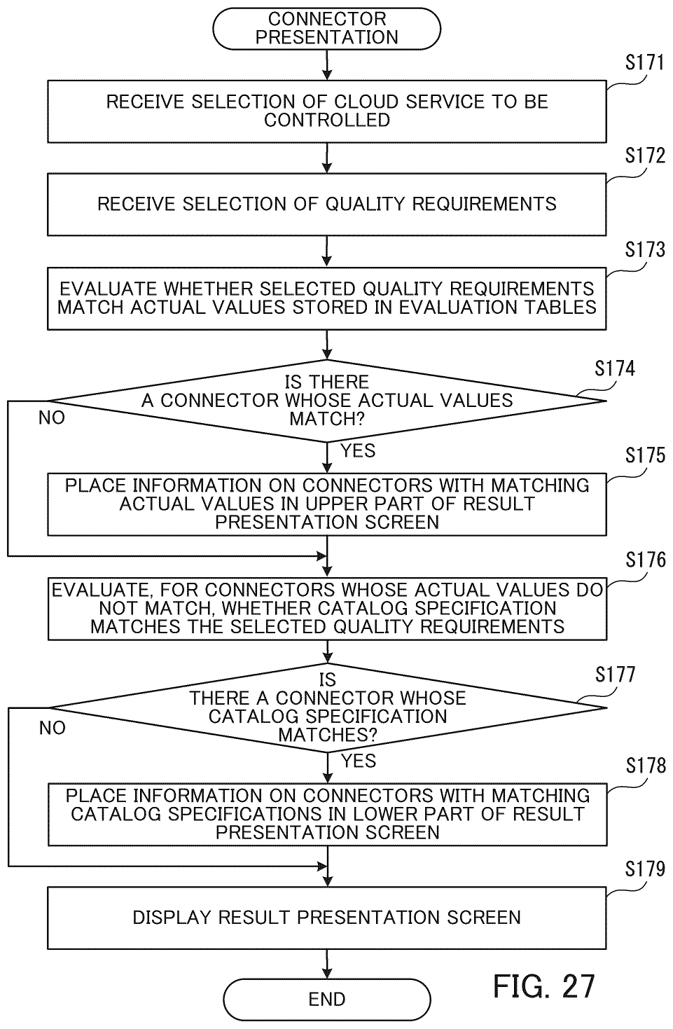

FIG. 27 is a flowchart depicting an example procedure of a connector presentation process. The processing depicted in FIG. 27 is described below in order of the step numbers.

[Step S171] The input reception unit 140 receives a selection of a cloud service to be controlled. As one example, the input reception unit 140 displays the connector type selection screen 51 on a user terminal (for example, the user terminal 300b) of a user who is newly using the workflow control service 31. The input reception unit 140 receives a selection of a cloud service corresponding to a check box that has been checked on the connector type selection screen 51.

[Step S172] The input reception unit 140 receives a selection of quality requirements. As one example, the input reception unit 140 causes the user terminal 300b to display the quality requirement selection screen 52. The input reception unit 140 receives a selection of quality requirements corresponding to check boxes that have been checked on the quality requirement selection screen 52.

[Step S173] The matching determination unit 150 evaluates whether the selected quality requirements match the actual values stored in the respective evaluation tables. As one example, the matching determination unit 150 refers to the correspondence table 122 and extracts, out of the connectors 110a, 110b, . . . , connectors corresponding to the cloud service whose selection was received in step S171. For each of the extracted connectors, the matching determination unit 150 evaluates whether the actual values satisfy all the quality requirements for which a selection was received in step S172.

[Step S174] The matching determination unit 150 determines whether there is a connector whose actual values match. As one example, when there is a connector that was evaluated in step S173 as having actual values that satisfy all of the quality requirements for which a selection was received in step S172, the matching determination unit 150 determines that there is a connector for which the actual values match. When the matching determination unit 150 has determined that there is a connector whose actual values match, the processing proceeds to step S175. On the other hand, when the matching determination unit 150 has determined that there is no connector whose actual values match, the processing proceeds to step S176.

[Step S175] The matching connector display unit 160 places information on the connectors whose actual values match in the upper part of the result presentation screen 53. As one example, the matching connector display unit 160 places the names of the connectors whose actual values match and the actual values of each quality requirement in the upper part of the result presentation screen 53.

[Step S176] The matching determination unit 150 evaluates, for connectors whose actual values did not match, whether the catalog specification stored in the respective evaluation tables matches the selected quality requirements. As one example, the matching determination unit 150 evaluates whether the catalog specifications satisfy all of the quality requirements for which a selection was received in step S172 for each of the connectors evaluated as having actual values that did not match out of the connectors extracted in step S173.

[Step S177] The matching determination unit 150 determines whether there is a connector whose catalog specification matches. As one example, when there is a connector evaluated in step S176 as having a catalog specification that satisfies all of the quality requirements for which a selection was received in step S172, the matching determination unit 150 determines that there is a connector whose catalog specification matches. When the matching determination unit 150 has determined that there is a connector whose catalog specification matches, the processing proceeds to step S178. When the matching determination unit 150 determines that there is no connector whose catalog specification matches, the processing proceeds to step S179.

[Step S178] The matching connector display unit 160 places information on the connectors whose catalog specification matches in the lower part of the result presentation screen 53. As one example, the matching connector display unit 160 places the names of connectors whose catalog specifications match and the actual values of the respective quality requirements in the lower part of the result presentation screen 53.

[Step S179] The matching connector display unit 160 displays the result presentation screen 53 on the user terminal 300b.

In this way, it is possible to present connectors, out of the connectors 110a, 110b, . . . , with a usage record that satisfies the quality requirements requested by the user to the user. This makes it possible for the user to appropriately select a connector to be used.

The control server 100 also presents connectors whose catalog specifications satisfy the quality requirements requested by the user to the user out of connectors that do not have a usage record that matches the quality requirements requested by the user. By doing so, it is possible to present a connector that satisfies the quality requirements requested by the user but has no usage record.

According to one aspect, it is possible to enable a user to appropriately select software that controls a cloud service.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
receiving an input of a quality requirement of control software that controls execution of a cloud service in keeping with a user input;
specifying control software whose usage record satisfies the quality requirement based on an execution log in which situations in which the control software was used are recorded; and
displaying the specified control software.

2. The non-transitory computer-readable storage medium according to claim 1,
wherein the process further includes:
specifying control software whose catalog specification satisfies the quality requirement, out of control software without a usage record that satisfies the quality requirement; and
displaying the specified control software.

3. The non-transitory computer-readable storage medium according to claim 1,
wherein the specifying of the control software whose usage record satisfies the quality requirement includes:
counting, based on the execution log, a number of parameters to be inputted in controlling the cloud service by the control software; and
specifying control software whose number of parameters satisfies the quality requirement.

4. The non-transitory computer-readable storage medium according to claim 1,
wherein the specifying of the control software whose usage record satisfies the quality requirement includes:
counting, based on the execution log, a number of executions of control of the cloud service executed in parallel by the control software; and
specifying control software whose number of executions satisfies the quality requirement.

5. The non-transitory computer-readable storage medium according to claim 1,
wherein the specifying of the control software whose usage record satisfies the quality requirement includes:
calculating, based on the execution log, a delay time caused by executing control of the cloud service in parallel by the control software; and
specifying control software whose delay time satisfies the quality requirement.

6. The non-transitory computer-readable storage medium according to claim 1,
wherein the specifying of the control software whose usage record satisfies the quality requirement includes:
specifying, based on the execution log, post-processing performed in response to the control of the cloud service by the control software having ended abnormally, and
specifying control software whose post-processing satisfies the quality requirement.

7. The non-transitory computer-readable storage medium according to claim 1,
wherein the specifying of the control software whose usage record satisfies the quality requirement includes:
specifying, based on the execution log, a type of log output function used by the control software in controlling the cloud service; and
specifying control software whose type of log output function satisfies the quality requirement.

8. The non-transitory computer-readable storage medium according to claim 1,
wherein the receiving of the input of the quality requirement includes receiving, as the quality requirement, an input of a completion standby process which stands by for completion of each of a plurality of processes that the control software has caused the cloud service to execute, and
the specifying of the control software whose usage record satisfies the quality requirement includes:
determining, based on the execution log, whether the control software has caused the completion standby process to be executed; and
specifying control software that has caused the completion standby process to be executed.

9. The non-transitory computer-readable storage medium according to claim 1,
wherein the receiving of the input of the quality requirement receives, as the quality requirement, an input of an execution status acquisition process that acquires an execution status of processing that the control software has caused the cloud service to execute, and
the specifying of the control software whose usage record satisfies the quality requirement includes:
determining, based on the execution log, whether the control software has caused the execution status acquisition process to be executed; and
specifying control software that has caused the execution status acquisition process to be executed.

10. The non-transitory computer-readable storage medium according to claim 1,
wherein the receiving of the input of the quality requirement receives, as the quality requirement, an input of an error termination status acquisition process that acquires a status in response to processing that the control software has caused the cloud service to execute having terminated in an error, and
the specifying of the control software whose usage record satisfies the quality requirement includes:
determining, based on the execution log, whether the control software has caused the error termination status acquisition process to be executed; and
specifying control software that has caused the error termination status acquisition process to be executed.

11. The non-transitory computer-readable storage medium according to claim 1,
wherein the receiving of the input of the quality requirement receives, as the quality requirement, an input of a forced termination process that forcibly terminates processing that the control software has caused the cloud service to execute, and
the specifying of the control software whose usage record satisfies the quality requirement includes:
determining, based on the execution log, whether the control software has caused the forced termination process to be executed; and
specifying control software that has caused the forced termination process to be executed.

12. The non-transitory computer-readable storage medium according to claim 1,
wherein the specifying of the control software whose usage record satisfies the quality requirement includes:
specifying, based on the execution log, a version of the cloud service that the control software is capable of controlling; and
specifying control software capable of controlling a version of the cloud service that satisfies the quality requirement.

13. An evaluation method comprising:
receiving, by a processor, an input of a quality requirement of control software which controls execution of a cloud service in keeping with a user input;
specifying, by the processor, the control software whose usage record satisfies the quality requirement based on an execution log in which situations in which the control software was used are recorded; and
displaying the specified control software.

14. An evaluation apparatus comprising:
a memory storing an execution log in which situations in which control software, which controls execution of a cloud service in keeping with a user input, was used is recorded; and
a processor coupled to the memory and the processor configured to:
receive an input of a quality requirement of the control software;
specify, based on the execution log, control software whose usage record satisfies the quality requirement; and
display the specified control software.
